(19) United States
(12) Patent Application Publication
(10) Pub. No.: US 2024/0417176 A1
(43) Pub. Date: Dec. 19, 2024

(54) Systems and Methods for Order Processing

(71) Applicant: OCADO INNOVATION LIMITED, Hatfield, Hertfordshire (GB)

(72) Inventors: Mohamed Adel Hamdi Naseer MAYADEEN, Hatfield, Hertfordshire (GB); John VALIX, Hatfield, Hertfordshire (GB); Steve SOLLY, Hatfield, Hertfordshire (GB); Aaron ROGERS, Hatfield, Hertfordshire (GB)

(73) Assignee: OCADO INNOVATION LIMITED, Trident Place, Mosquito Way (GB)

(21) Appl. No.: 18/701,340

(22) PCT Filed: Oct. 14, 2022
(86) PCT No.: PCT/EP2022/078740

§ 371 Date: Apr. 15, 2024

(30) Foreign Application Priority Data
Oct. 14, 2021 (GB) 2114723.6
Oct. 14, 2021 (GB) 2114725.1
Dec. 20, 2021 (GB) 2118530.1
Dec. 20, 2021 (GB) 2118537.6

(51) Int. Cl. B65G 1/137; B65G 1/04

(52) U.S. Cl. CPC B65G 1/1378; B65G 1/0464; B65G 1/0485

(57) ABSTRACT

A combination and separation apparatus for combining and separating a delivery container and a storage container. The apparatus incudes a storage container station, a delivery container station, a combined station, and a merge/separation station. The merge/separation station is configured to combine the storage container and the delivery container, and or the merge/separation station is configured for separating the storage container and the delivery container.

### FIELD OF THE INVENTION

The present invention relates to the field of automated order fulfilment systems. In particular, the present invention relates to an improved system and method for the handling, or manipulation of containers in fully or semi-automated storage and retrieval systems.

### BACKGROUND

Various forms of both fully- and semi-automated order processing and fulfilment systems are known. They, and the various components they comprise, may take many forms.

In some forms of goods-to-man picking systems, for example, bins or other storage containers containing inventory and/or other items may be stored within, and retrieved from, a storage and retrieval system, in order to facilitate picking of items from the storage containers at picking stations. Pallet goods and/or other multi-packs of inbound items are separated and placed, individually or in groups corresponding to their stock keeping unit (SKU) into separate storage containers for storage in the storage and retrieval system.

Storage and retrieval systems typically comprise a three-dimensional storage grid framework structure, within which storage containers/bins are stacked on top of each other, are well known. PCT Publication No. WO2015/185628A (Ocado) describes a known storage and fulfilment system in which stacks of bins or containers are arranged within a grid framework structure. The bins or containers are accessed by load handling devices remotely operative on tracks located on the top of the grid framework structure. A system of this type is illustrated schematically in FIGS. 1 to 3 of the accompanying drawings. For the avoidance of doubt, the term “grid framework structure” is used to mean a three-dimensional structure within which the storage containers are stored, and 30 the terms “grid structure” and “grid” are used interchangeably to mean the two-dimensional structure in a substantially horizontal plane upon which the load handling devices operate.

As shown in FIGS. 1 and 2, stackable containers, known as bins or containers 10, are stacked on top of one another to form stacks 12. The terms “bin”, “container”, “storage container” and “tote” are used interchangeably in this description to refer to the same object. The stacks 12 are arranged in a grid framework structure 14 in a warehousing or manufacturing environment.

The grid framework structure is made up of a plurality of storage columns or grid columns 15. Each grid in the grid framework structure has at least one grid column for storage of a stack of containers. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application.

The three-dimensional grid framework structure 14 comprises a plurality of upright members or upright columns 16 that support horizontal members 18, 20. A first set of parallel horizontal grid members 18 is arranged perpendicularly to a second set of parallel horizontal grid members 20 to form a grid structure lying in a horizontal plane and supported by the upright members 16. The members 16, 18, 20 are typically manufactured from metal and typically welded or bolted together or a combination of both. The bins 10 are stacked between the members 16, 18, 20 of the grid framework structure 14, so that the grid framework structure 14 guards against horizontal movement of the stacks 12 of bins 10, and guides vertical movement of the bins 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

As an alternative to the grid framework structure 14 supporting the 2D grid directly on a plurality of upright columns 16 as described with reference to FIG. 1, in other examples the grid framework structure supports the 2D grid on top of a plurality of prefabricated modular panels arranged in a grid pattern, the detail of which is described briefly below and fully in the PCT application, WO2022034195A1, in the name of Ocado Innovation Ltd, and incorporated herein by reference. This grid framework structure described in WO2022034195A1 addresses the problem of time and cost to assemble by supporting the 2D grid on a supporting framework structure comprising a plurality of prefabricated modular panels arranged in a three dimensional grid pattern to define a plurality of grid cells. Each of the grid cells of the supporting framework structure is sized to support two or more grid cells of the 2D grid upon which the load handling devices operate. The grid framework structure is formed from fewer structural components yet still maintains the same structural integrity as the typical “stick-built” grid framework structure 14 described above, and is much faster and cheaper to build.

The prefabricated modular panels of the grid framework structure described above comprise upright columns 16. For example, a sub-group of the upright columns can be braced by one or more bracing members to form prefabricated panels or frames. For the purpose of the present invention, the plurality of upright columns 16 can also include the upright columns 16 in the prefabricated panels. The grid framework structure can comprise any appropriate supporting framework structure to support the grid, including upright columns 16 directly supporting the grid, and/or prefabricated panels and/or frames incorporating upright columns 16.

A known load handling device 30 shown in FIGS. 4 and 5 comprising a vehicle body 32 is described in PCT Patent Publication No. WO2015/019055 (Ocado), hereby incorporated by reference, where each load handling device 30 only covers one grid space of the grid framework structure 14. Here, the load handling device 30 comprises a wheel assembly comprising a first set of wheels 34 consisting a pair of wheels on the front of the vehicle body 32 and a pair of wheels 34 on the back of the vehicle 32 for engaging with the first set of rails or tracks to guide movement of the device in a first direction and a second set of wheels 36 consisting of a pair of wheels 36 on each side of the vehicle 32 for engaging with the second set of rails or tracks to guide movement of the device in a second direction. Each of the set wheels are driven to enable movement of the vehicle in X and Y directions respectively along the rails. One or both sets of wheels can be moved vertically to lift each set of wheels clear of the respective rails, thereby allowing the vehicle to move in the desired direction.

The load handling device 30 is equipped with a lifting device (lifting mechanism) or crane mechanism to lift a storage container from above. The crane mechanism comprises a winch, a tether or cable 38 wound on a spool or reel (not shown) and a grabber device 39. The lifting device or crane mechanism comprise a set of lifting tethers 38 extending in a vertical direction and connected nearby or at the four corners of a lifting frame 39, otherwise known as a grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2. The grabber device comprises a plurality of grippers that are configured to grip a storage container when actuated by an actuator.

The wheels 34, 36 are arranged around the periphery of a cavity or recess, known as a container-receiving recess or container receiving space 40, in the lower part of the load handling device. The recess is sized to accommodate the container 10 when it is lifted by the crane mechanism, as shown in FIG. 5 (a and b). When in the recess, the container is lifted clear of the rails beneath, so that the vehicle or load handling device can move laterally to a different location. On reaching the target location, for example another stack, an access point in the storage system or a conveyor belt, the bin or container can be lowered from the container receiving portion and released from the grabber device.

The container receiving space 40 may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS) in which case the container receiving space is located below a cantilever of the load handing device. In this case, the grabber device is hoisted by a cantilever such that the grabber device is able to engage and lift a container from a stack into a container receiving space below the cantilever.

Upon receipt of a customer order, a load handling device operative to move on the tracks is instructed to pick up a storage container containing the item of the order from a stack in the grid framework structure and transport the storage bin to a pick station whereupon the item can be retrieved from the storage bin. Order picking stations can include various forms of systems for receiving storage containers of items retrieved by the storage and retrieval system so as to enable picking of items therefrom, for placement in delivery containers. Such systems typically includes various types and forms of conveyor or trolley based systems, wherein storage containers are loaded on conveyors or picking trolleys for transport to picking areas for automated and/or manual removal of items and placed in delivery containers, which are often of different type(s) than those used to store items, and which are provided by systems or other sources outside the storage system.

Orders assembled for delivery frequently comprise multiple delivery containers. Individual delivery containers, once they have been suitably filled with picked items, are typically set aside in separate order sortation or handling systems until all required delivery containers for an order or a whole delivery vehicle are ready. At that time the multiple containers required to fill the order are assembled and provided to a dispatch facility for loading or delivery.

Empty delivery containers may be returned, following delivery, to the sorting or dispatch area and fed back into the separate order sortation and handling system for re-use. In other embodiments, delivery containers may be in the form of cartons, which are not returned.

While the use of separate order sortation and handling systems can work well for relatively small installations, handling up to, for example, a few thousand bin retrievals per hour, and either relatively few customer orders per hour or relatively few items per customer order, with large systems, involving tens of thousands of bin retrievals per hour or more, and hundreds or thousands of customer orders, each comprising tens of different items, this can become a bigger problem, requiring extensive conveyor systems for transport and sortation of Order Containers.

WO2014/203126 (Ocado Innovation Limited) teaches a system and method for order processing where a delivery container may be placed inside a storage container to form a storage container combination. The upper edges of the delivery containers do not protrude above the upper edges of the storage containers, when placed therein. This allows the storage container combination to be stored within the grid framework structure. One or more delivery containers can be placed inside storage containers at the dispatch facility or between the dispatch facility and the storage and retrieval system. One or more shopping or other bags may be placed within the delivery containers; and the resulting storage container combination can be placed within the grid framework structure until needed at an order picking station. At an order picking station, delivery container(s) within a combination may be stocked with items picked from the same or different storage containers. When all delivery container(s) associated with an order have been appropriately filled, the storage combination is retrieved by the storage and retrieval system, where it is stored until the appropriate time when it is required for fulfilling an order, at which stage the storage combination is transferred to a dispatch facility. At the dispatch facility, the filled delivery containers are removed from its combination(s) and loaded or otherwise processed for delivery. WO2014/203126 (Ocado Innovation Limited) teaches an apparatus to place delivery containers into storage containers with the help of the load handling devices. Here, bagged, delivery containers can arrive by conveyor to a transfer station. Storage containers can be deposited by the load handling devices onto the transfer stations and then moved by conveyor to a merge station conveyor. A transfer mechanism lifts the delivery container and moves it over the merge station conveyor. The merge station conveyor with the empty storage container can then be elevated by a lifting mechanism and the delivery container released from the transfer mechanism. The combined delivery and storage containers can now be transferred from the merge station conveyor onto a conveyor and on to a pick-up station. From the pick-up stations, the combined delivery and storage containers can be retrieved by the load handling devices and taken to an order picking station.

To separate the delivery container from the combined delivery container and storage container, typically a load handling device deposits the combined delivery container and storage container onto a transform platform. The delivery container is then secured by clamps, which can travel vertically on a lift mechanism. Whilst the delivery container is secured by the clamps, the transfer platform drop down and moves sideways carrying the storage container away from the delivery container. The clamps can now move down using a lift mechanism and deposit the delivery container to a transfer location where a conveyor or other mechanisms can transfer the delivery container to another location.

Whilst the art, WO2014/203126 (Ocado Innovation Limited), teaches an apparatus to automatically combine and separate a delivery container and a storage container, the apparatus occupies a significant proportion of the footprint of the storage and retrieval system requiring significant alternations to be made to the grid framework structure to accommodate the apparatus. For example, multiple feed and retrieval stations are required to feed and retrieve the combined delivery container and storage container to and from storage in the grid framework structure. An apparatus for combining and separating a delivery container and a storage container is thus required that occupies less footprint of the storage and retrieval system and is able to be incorporated into the storage and retrieval system with minimum alteration to the grid framework structure.

This application claims priority from GB application no. GB2114725.1 filed on 14 Oct. 2021, GB application number GB2118530.1 filed on 20 Dec. 2021, GB application number GB2114723.6 filed on 14 Oct. 2021, and GB application number GB2118537.6 filed on 20 Dec. 2021, there contents being herein incorporated by reference.

### SUMMARY OF THE INVENTION

The present invention has mitigated the above problem by providing a combination and separation apparatus for combining and separating a delivery container and a storage container, the delivery container being able to be contained within the storage container, the apparatus comprising:
i) a storage container station configured for conveying a storage container in a first direction;
ii) a delivery container station configured for conveying a delivery container in a second direction;
iii) a combined station configured for conveying a combined delivery container and storage container in a third direction;
iv) a merge/separation station comprising a clamping device for clamping a delivery container and a lifting device configured for combining or separating a storage container and a delivery container;
wherein the merge/separation station is configured for combining the storage container and the delivery container when the storage container station and the delivery container station are configured for respectively conveying the storage container and the delivery container to the merge/separation station and the combined station is configured for receiving the combined delivery container and storage container from the merge/separation station; and/or
the merge/separation station is configured for separating the storage container and the delivery container when the combined station is configured for conveying a combined delivery container and delivery container to the merge/separation station and the storage container station and the delivery container station are configured to respectively receive the storage container and the delivery container from the merge/separation station;
wherein the first, second and third direction are parallel to each other.

Configuring the storage container station, delivery container station, the merge/separation station such that they are configured to respectively convey a storage container, a delivery container and a combined delivery container and storage container respectively in parallel directions not only reduces the footprint of the apparatus but simplifies the construction of the apparatus. For the purpose of the present invention, the term “convey” or “conveying” covers feeding or receiving in a direction. Preferably, any one of the storage container station, delivery container station, combined station and the merge/separation station comprises a transfer mechanism configured for transferring a respective storage container, delivery container or combined delivery container and storage container between the merge/separation station and their respective storage container station, delivery container station or the combined station. Optionally, the transfer mechanism comprises at least one conveyor unit. For example, the storage container station may comprise a storage container conveyor unit configured for feeding or receiving a storage container in a first direction. Similarly, the delivery container station may comprise a delivery container conveyor unit configured for feeding or receiving a storage container in a second direction and the combined station comprises a combined conveyor unit configured for feeding or receiving a combined delivery container and storage container in a third direction. This could be by the conveyor unit comprising a drive mechanism to drive the movement of the storage container or the delivery container or the combined delivery container and the storage container to and from the merge/separation station and the other stations. Alternatively or in addition to the conveyor unit, the transfer mechanism may be configured to transfer the clamping device between the merge/separation station and the delivery container station. Thus, instead of the delivery conveyor unit being configured for feeding the delivery container to the merge/separation station, the transfer mechanism can be configured to transfer the clamping device between the delivery container station and the merge/separation station. Thus, a delivery container clamped to the clamping device can be transferred between merge/separation station and the delivery container station.

The first, second and third directions are parallel to each other, i.e. the first direction is parallel to the second direction, and the second direction is parallel to the third direction and the first direction is parallel to the third direction. The footprint of the combination and separation apparatus is determined by the movement of the storage containers along the first, second and third directions. Since the first, second and third directions lie in the same axis, the storage containers move along a single axis and therefore the footprint of the combination and separation apparatus may occupy a row of three aligned storage containers. By having the first, second and the third directions being parallel to each other, the apparatus can additionally function either as a combination apparatus, in which case the apparatus is configured for combining a delivery container and a storage container, or a separation apparatus, in which case the apparatus is configured for separating a delivery container and a storage container. In the case where the apparatus functions as a combination apparatus, then the present invention provides a combination apparatus for combining a delivery container and a storage container, the delivery container being able to be contained within the storage container, the apparatus comprising:
i) a merge station comprising a clamping device configured to clamp a delivery container and a lifting device for combining a storage container and a delivery container,
ii) a storage container station configured for conveying a storage container in a first direction to the merge station;
iii) a delivery container feeding station configured for conveying a delivery container in a second direction to the merge station;
iv) a combined station configured for receiving a combined delivery container and storage container fed from the merge station;
wherein the first direction is parallel to the second direction.

In the case where the apparatus functions as a separation apparatus, then the present invention provides a separation apparatus for separating a combined delivery container and a storage container, the delivery container being able to be contained within the storage container, the apparatus comprising:
i) a separation station comprising a clamping device configured to clamp a delivery container and a lifting device for separating a storage container and a delivery container;
ii) a storage container station configured for conveying a storage container in a first direction from the separation station;
iii) a delivery container station configured for receiving a delivery container in a second direction from the separation station;
iv) a combined station configured for conveying a combined delivery container and storage container into the separation station;
wherein the first direction is parallel to the second direction.

Optionally, the lifting device is arranged for lifting or lowering a storage container towards or away from the delivery container so as to combine or separate a storage container and a delivery container clamped to the clamping device. In the case where the lifting device is configured for lifting or lowering a storage container towards or away from the delivery container, preferably the transfer mechanism of the merge/separation station comprises a merge/separation conveyor unit and the lifting device is arranged for lifting or lowering the merge/separation conveyor unit to combine the storage container with the delivery container in a raised position of the merge/separation conveyor unit and lower the storage container away from the delivery container to separate the delivery container and the storage container in a lowered position of the merge/separation conveyor unit. Optionally, the delivery container station is directly opposite the combined station such that in the raised or lowered position of the merge/separation conveyor unit, a continuous conveyor system extends from the delivery container conveyor unit to the combination conveyor unit via the merge/separation conveyor unit. Optionally, the delivery container station is directly opposite the combined station such that in the raised or lowered position of the merge/separation conveyor unit, a continuous conveyor system extends from the delivery container station to the combined station via the merge/separation station.

Alternatively or in addition, the lifting device is arranged for lifting or lowering a delivery container towards or away from the storage container so as to combine or separate a storage container and a delivery container clamped to the clamping device. For example, the lifting device can be configured for lowering or raising the clamping device.

In terms of the layout of the different stations of the apparatus, optionally, the combined station is arranged directly above the storage container station. Equally, the combined station is arranged directly below the delivery container station. In order to reduce the footprint of the apparatus in comparison to a prior art apparatus, preferably, the merge/separation station, the storage container station, the delivery container station, and the combined station all lie in the same vertical plane.

To simplify the feeding or receiving of the storage container and/or the delivery container and/or the combined delivery container and the storage container, preferably the merging/separation station is arranged between the storage container feeder station and the delivery container feeding station.

In order for the apparatus to combine or separate a delivery container and a storage container, it is necessary that the apparatus comprises a clamping device to clamp the delivery container whilst it is being combined or separated from a storage container. In addition, to enable the combined delivery container and storage container to be stored in the vertical storage columns bound by the vertical members and to engage with the grabber device of a load handling device, it is necessary that the delivery container does not protrude above the upper edges of the storage container when combined with the storage container. Thus, to allow the combined storage container and the delivery container to be stored in the grid framework structure as well as to enable the delivery container to be clamped whilst being combined with the storage container, at least one side wall of the storage container comprises a cut-out such that when the delivery container is placed or nested inside the storage container, the cut-out extends below the height of the delivery container so exposing at least a portion of the side wall of the delivery container. Typically, at least one side wall of the delivery container comprises a delivery container handle such that the delivery container handle can be engaged to remove or place the delivery container into the storage container. To enable the delivery container handle to be engaged, e.g. by the clamping device, it is necessary that the delivery container is correctly positioned relative to the clamping device.

Optionally, the merging/separation station further comprises an alignment mechanism arranged to position the delivery container relative to the clamping device so as to enable the clamping device to clamp the at least one side wall of the delivery container when combined with the storage container. Optionally, the alignment mechanism comprises at least two inserts or locating pins that are arranged to be inserted in the spacing between the storage container and the delivery container so as position the delivery container relative to the clamping device. Preferably, the lifting device is arranged for lifting the storage containers into engagement with the alignment mechanism. The at least two inserts or locating pins are diagonally opposed and sized such that when inserted in the spacing between the storage container and the delivery container when combined, the delivery container is correctly positioned relative to the clamping device. Preferably, at least a portion of the at least two inserts or locating pins is wedge shaped so as to enable the at least two inserts or locating pins to be inserted in the spacing between the storage container and the delivery container without fouling the edges of either the storage container and/or the delivery container.

To further correctly position the storage container relative to the delivery container when being combined, the merging/separation station further comprises a datum edge and a datum clamp, said datum clamp being arranged for clamping a storage container against the datum edge so as to position the storage container relative to the clamping device, i.e. the alignment mechanism further comprises the datum edge and the datum clamp. The datum edge provides a reference point for the storage container to correctly position the storage container relative to the delivery container above, more specifically, position the open end of the storage container relative to the delivery container. This allows the storage container to encircle the delivery container when the delivery container is nested within the storage container. Such re-positioning prevents any misalignment of the storage container and the delivery container causing both storage container and delivery container to crash into each other when being lifted towards each other. The datum clamp is configured to push the storage container against the datum edge such that an edge of the storage container butts up against the datum edge and thereby, correctly position the storage container relative to the delivery container.

Having the storage container conveyor station, the delivery container station and the merge/separation station being configured to convey their respective storage container, delivery container and the combined delivery container and storage container in a substantially parallel direction allows the apparatus of the present invention to be used interchangeably as a combination apparatus or a separation apparatus. This reduces the number of different spare parts separately required for the combination apparatus and the separation apparatus since the same parts can be used for both the combination apparatus and the separation apparatus.

Preferably, the present invention provides an order processing system comprising:
i) a first combination and separation apparatus, said first combination and separation apparatus being the combination and apparatus according to the present invention and being arranged to separate a combined delivery container and storage container into a delivery container and a storage container;
ii) a second combination and separation apparatus, said second combination and separation apparatus being the combination and apparatus according to the present invention and being arranged to combine the storage container separated from the first combination and separation apparatus with a delivery container;
iii) a bridge configured for feeding a storage container in a fourth direction from the first combination and separation apparatus to the second combination and separation apparatus.

Multiple apparatuses of the present invention can be assembled together such that one apparatus can be configured to function as a separation apparatus to separate a combined delivery container and storage container and another apparatus can be configured to function as a combination apparatus to combine a delivery container and a storage container, i.e. the apparatus of the present invention can modularised. A bridge station can be interposed between the first apparatus and the second apparatus such that a storage container separated from the first apparatus can be transferred in a fourth direction to the second apparatus whereupon the second apparatus can be configured to combine the storage container with a fresh delivery container. Optionally, the fourth direction is substantially perpendicular or orthogonal to the first, second and third directions.

The order processing system of the present invention can be integrated into a storage and retrieval system comprising a three dimensional grid framework structure and one or more load handling devices operative on the three dimensional grid framework structure. Preferably, the order processing system further comprises:
i) a three dimensional grid framework structure comprising a plurality of upright members arranged to form a plurality of vertical storage columns for one or more combined delivery and storage containers to be stacked between the upright members and be guided by the upright members in a vertical direction, wherein the plurality of upright members are interconnected by a plurality of grid members arranged in grid pattern to form a grid structure comprising a plurality of grid cells; said plurality of vertical storage columns comprising at least one delivery port column being arranged for delivering a combined delivery container and storage container in a vertical direction through a grid cell to the first combination and separation apparatus and at least one pick-up port column being arranged for a combined delivery container and storage container in a vertical direction through a grid cell from the second combination and separation station; and
ii) one or more load handling devices operative on the grid structure for transporting a combined delivery container and storage container to the at least one delivery port column and/or for picking up a combined delivery container and storage container from the at least one pick-up column, each of the one or more load handling devices comprising a lifting device for lifting and/or lowering a combined delivery container and storage container.

Preferably, the at least one delivery port column and/or the at least pick-up port column comprises a vertical chute having an opening in cooperation with a grid cell of the grid structure for delivering or picking-up a combined delivery container and storage container by a load handling device through a grid cell. More specifically, the apparatus further comprises a vertical chute having a first opening in cooperation with a grid cell and a second opening leading to the combined station of the apparatus.

A load handling device operative on the grid structure can be instructed to deliver a combined delivery container and storage container through a vertical chute via its lifting mechanism to the combined station of the apparatus, whereupon the combined station is configured to convey the combined delivery container and storage container to the merge/separation station.

Similarly, a combined delivery container and storage container can be fed from the merge/separation station to a pick-up chute, whereby a load handling device operative on the grid structure can pick-up the combined delivery container and storage container and return it for storage in a grid framework structure. For the purpose of the present invention, the grid members comprises tracks or rails arranged in the grid pattern. The tracks or rails can be integrated into the grid members, e.g. by extrusion, or alternatively, secured to the grid members, e.g. by a snap-on arrangement or use of fasteners.

Alternatively or in addition to a load handling device delivering or picking up a combined delivery container and storage container from a respective vertical chute, the at least one of the delivery port column and/or the at least pick-up port column comprises at least one bin lifting device for lifting or lowering a combined delivery container and storage container at least partially along their respective vertical chute, i.e. along the a least one of the delivery port column and/or the at least pick-up port column. The bin lifting device could be hydraulic driven or belt driven and be integrated into the vertical chute and be arranged to transport a combined delivery container and storage container in a vertical direction at least partially along the vertical chute. For example, the bin lifting device of the vertical chute can work together with the lifting mechanism of the load handling device to transport a combined delivery container and storage container along the vertical chute to and from the apparatus of the present invention.

The present invention further provides a method of operating an order processing system of the present invention, comprising the steps of.
i) transporting a combined delivery container and storage container in a vertical direction down the at least one delivery port column to the first combination and separation apparatus;
ii) separating the delivery container and the storage container in the merge/separation station; iii) moving the separated storage container to the second combination and separation apparatus;
iv) combining the separated storage container with a delivery container in the second combination and separation apparatus;
v) transporting the combined delivery container and storage container in a vertical direction up the at least one pick-up port column towards the grid structure.

Optionally, the combined delivery container and storage container is transported in a vertical direction down the at least one delivery column and/or up the at least one pick-up column by the lifting device of the load handling device operative on the grid structure. Alternatively or in addition to the combined delivery container and storage container being transported by the lifting device of the load handling, optionally, the combined delivery container and storage container can be transported in a vertical direction down the at least one delivery column and/or up the at least one pick-up column by the bin lifting device.

The ability of nesting the delivery container within the storage container has provided the advantage that the delivery container can be stored in the storage and retrieval system until when required by an order picking station. This greatly improves the sortation of the delivery containers for dispatch at the dispatch facility. To allow the delivery container to be placed inside the storage container to form a storage container combination, the upper edges of the delivery container do not protrude above the upper edges of the storage containers, when placed therein. However, once the delivery container is placed inside the storage container, there needs to be an effective way to remove the delivery container from the storage container. The present invention has mitigated the above problem by providing a combination and separation apparatus for combining and separating a delivery container and a storage container, the delivery container being containable within the storage container, the apparatus comprising:
i) a clamping device configured for clamping a delivery container;
ii) a lifting device configured for combining and separating a storage container and a delivery container;
iii) an alignment mechanism configured for engaging with the delivery container to align the delivery container relative to the clamping device.

It is essential that the delivery container is clamped in order for the storage container to be separated from the delivery container. To clamp the delivery container, it is important that the delivery container is correctly positioned relative to the clamping device in order for the clamping device to properly engage with the delivery container. Without correctly positioning the delivery container relative to the clamping device, there is risk that the clamping device may not correctly engage with the delivery container. The provision of the alignment mechanism according to the present invention enables the delivery container to be correctly positioned so as to be positively engaged by the clamping device. Optionally, the alignment mechanism is configured for engaging with at least one side wall of the delivery container.

Preferably, at least one sidewall of the storage container comprises at least one cut-out so as to expose the at least one sidewall of the delivery container through the at least one cut-out. This is to allow the clamping device to engage with the at least one side wall of the delivery container through the cut-out in the storage container.

In one exemplary embodiment of the present invention, the alignment mechanism comprises a centring device comprising one or more guides configured for engaging with the exterior surface of the delivery container such that the one or more guides centres the delivery container relative to the storage container when the delivery container is nested within the storage container. Optionally, the one or more guides is mounted to a frame such that the one or more guides is arranged to centre the delivery container relative to the frame when the one or more guides engages with the exterior surface of the delivery container.

Optionally, the one or more guides comprises a plurality of locating pins configured for engaging with the exterior surface of the delivery container. The plurality of locating pins can be configured to engage with opposing sidewalls of the delivery container. Optionally, the plurality of locating pins are diagonally opposed so as to engage with the corners of the delivery container. The spacing between the locating pins are such so as to engage with the exterior surface of the delivery container. Any slight misalignment of the delivery container to prevent the clamping device engaging with the delivery container, engagement with the plurality of locating pins repositions the delivery container so that it is in the correct position relative to the clamping device. To enable the plurality of locating pins to engage with the exterior surface of the delivery container, at least a portion of each of the plurality of locating pins is wedge shaped. The inclined surface of the wedge shaped locating pins interact with the exterior surface of the delivery container so as to guide the delivery container into the correct position relative to the storage container when combined together, i.e. nested. Preferably, the lifting device is configured for lifting the delivery container into engagement with the alignment mechanism.

Optionally, the clamping device, the lifting device and the alignment mechanism defines a merge/separation station; and wherein the apparatus further comprises a combined station configured for conveying a combined delivery container and storage container into the merge station.

The clamping device, the lifting device and the alignment mechanism can form part of an apparatus where the clamping device, the lifting device and the alignment mechanism defines a merge/separation station and the apparatus further comprises a combined station configured for conveying a combined delivery container and storage container into the merge station. To combine a delivery container and storage container in the merge/separation station, preferably the apparatus further comprises:
i) a storage container station configured for conveying a storage container to the merge/separation station;
ii) a delivery container station configured for conveying a delivery container to the merge/separation station.

Preferably, the apparatus further comprises a transfer mechanism configured for transferring the clamping device between the merge/separation station and the delivery container station. This allows the clamping device to pick up a delivery container from the delivery container station and transfer it to the merge/separation station where it is subsequently combined with a storage container. Equally, the clamping device can transfer a delivery container separated in the merge/separation station to the delivery container station.

Preferably, the clamping device comprises a pair of clamps configured for engaging with at least one side wall of a delivery container. Alternatively, the clamping device comprises a pair of arms moveable to clamp at least one side wall of the delivery container. To allow the pair of clamps to engage with the at least one side wall of a delivery container, preferably at least one of the pair of clamps comprises at least one engagement pin configured for being received into an opening in a delivery container. The alignment mechanism of the present invention ensures that the at least one engagement pin of the at least one clamp is correctly received in an opening in a delivery container.

To further ensure alignment of the delivery container with respect to the storage container, preferably, the alignment mechanism further comprises a datum edge and a datum clamp, said datum clamp being arranged for clamping a storage container against the datum edge so as to position the storage container relative to clamping device.

Other means to combine and separate the delivery container and the storage container besides conveying the delivery container and the storage container into a merge/separation station is applicable in the present invention. In another exemplary embodiment of the present invention, the lifting device comprises a robot having a robot base, and a robot arm coupled to the robot base, wherein an end effector is coupled to the robot arm for controlling the movement of the end effector to combine and separate a delivery container and a storage container, said end effector comprising the clamping device and the alignment mechanism. Combining and separating the delivery container and the storage container can be carried out by a robot having a robot arm that is coupled to an end effector such that the robot arm can control the movement of the end effector, i.e. lift. Having the end effector to comprise the clamping device and the alignment mechanism of the present invention permits the robot to combine and separate a delivery container and a storage container. This has the advantage that the robot base can be mounted to a grid cell and thus, the separation and combination of the delivery container and the storage container can be carried out on the grid structure. Not only does this help with the sortation of the delivery container in storage in the grid framework structure but removes or reduces the need to feed the combined delivery container and storage container down a delivery port column in the grid structure to a combination and separation apparatus external of the grid framework structure.

The present invention further provides an order processing system comprising;
i) a combination and separation apparatus according to the present invention;
ii) a three dimensional grid framework structure comprising a plurality of upright members arranged to form a plurality of vertical storage columns for one or more combined delivery and storage containers to be stacked between the upright members and be guided by the upright members in a vertical direction, wherein the plurality of upright members are interconnected by a plurality of grid members arranged in a grid pattern to form a grid structure comprising a plurality of grid cells; said plurality of vertical storage columns comprising at least one delivery port column being arranged for delivering a combined delivery container and storage container in a vertical direction through a grid cell to the combination and separation apparatus and at least one pick-up port column being arranged for receiving a combined delivery container and storage container in a vertical direction through a grid cell from the combination and separation station; and
iii) one or more load handling devices operative on the grid structure for transporting a combined delivery container and storage container to the at least one delivery port column and/or for picking up a combined delivery container and storage container from the at least one pick-up column, each of the one or more load handling devices comprising a lifting device for lifting and/or lowering a combined delivery container and storage container.

Optionally, the at least one delivery port column and/or the at least pick-up port column comprises a vertical chute having an opening in cooperation with a grid cell of the grid structure for delivering or picking-up a combined delivery container and storage container by a load handling device through the grid cell.

Optionally, the at least one delivery port column and/or the at least pick-up port column comprises a bin lifting device for lifting or lowering a combined delivery container and storage container at least partially along their respective vertical chute.

In another aspect of the present invention, an order processing system for combining and separating a delivery container and a storage container stored in a three dimensional grid framework structure is provided, the system comprising:
i) a three dimensional grid framework structure comprising a plurality of upright members arranged to form a plurality of vertical storage columns for one or more combined delivery and storage containers to be stacked between the upright members and be guided by the upright members in a vertical direction, wherein the plurality of upright members are interconnected by a plurality of grid members arranged in a grid pattern to form a grid structure comprising a plurality of grid cells;
ii) a combination and separation apparatus comprising a robot discussed above, wherein the robot base of the robot is mounted to at least one of the plurality of grid cells such that the robot arm is configured for moving the end effector into a grid cell so as to effect separation and combination of the delivery container and the storage container.

### BRIEF DESCRIPTION OF THE DRAWINGS

Further features and aspects of the present invention will be apparent from the following detailed description of an illustrative embodiment made with reference to the drawings, in which:

FIG. 1 is a schematic diagram of a grid framework structure according to a known system,

FIG. 2 is a schematic diagram of a top down view showing a stack of bins arranged within the framework structure of FIG. 1.

FIG. 3 is a schematic diagram of a system of a known load handling device operating on the grid framework structure.

FIG. 4 is a schematic perspective view of the load handling device showing the lifting device gripping a container from above.

FIGS. 5(a) and 5(b) are schematic perspective cut away views of the load handling device of FIG. 4 showing (a) the container receiving space of the load handling device and (b) a container accommodated within the container receiving space of the load handling device.

FIG. 6 is a schematic flow diagram illustrating aspect of the order processing system according to an embodiment of the present invention.

FIG. 7 is a perspective view of the combination and separation apparatus according to an embodiment of the present invention.

FIG. 8 is a perspective view of (a) delivery container, (b) storage container; and (c) combined delivery container and storage container.

FIG. 9 is a perspective view of the clamping device of the merge/separation apparatus of the combination and separation apparatus according to an embodiment of the present invention.

FIG. 10 are schematic diagrams of the stages of combining a delivery container and a storage container in the combination and separation apparatus showing (a) clamping the delivery container in the delivery container station; (b) transporting the delivery container and the storage container to the merge/separation station; (c) combining the delivery container and the storage container in the merge/separation station; and (d) transporting the combined delivery container and storage container to the combined station

FIG. 11 are schematic diagrams of the stages in the separation of a delivery container and a storage container in the combination and separation apparatus showing (a) clamping the delivery container in the delivery container and storage container combination; (b) lowering the merge/separation conveyor unit to separate the delivery container and the storage container; and (c) transporting the separated delivery container to the delivery container station.

FIGS. 12a and 12b are a perspective views of a container sortation system according to an embodiment of the present invention showing 12a perspective view of the container sortation system; and 12b a top view of the container sortation system.

FIG. 13 is a perspective view showing an order processing system according to an embodiment of the present invention comprising a first combination and separation apparatus for separating a combined delivery container and storage container; and a second combination and separation apparatus for combing a fresh delivery container and the separated storage container.

FIG. 14 is a perspective view showing the integration of the order processing system into the storage and retrieval system according to the embodiment of the present invention.

FIG. 15 is a perspective view showing an end effector comprising the alignment mechanism and clamping device mounted to a robot arm.

FIG. 16 is a perspective view showing the robot comprising the robot arm supporting the end effector in FIG. 15 mounted to a grid cell of a grid structure.

FIG. 17 is a top view of the container sortation system.

FIG. 18a is a schematic view of a container sortation system comprising a vision system, showing a top view

FIG. 18b is a schematic view of a container sortation system comprising a vision system, showing a perspective view.

FIG. 19 is a schematic view of the vision system of FIGS. 18a and 18b.

FIG. 20 is (a) a photograph, and (b) a schematic diagram of the field of view of a camera in a vision system.

FIG. 21 is a flowchart describing how the vision system compensates for misalignment of the delivery container within the storage container.

### DETAILED DESCRIPTION

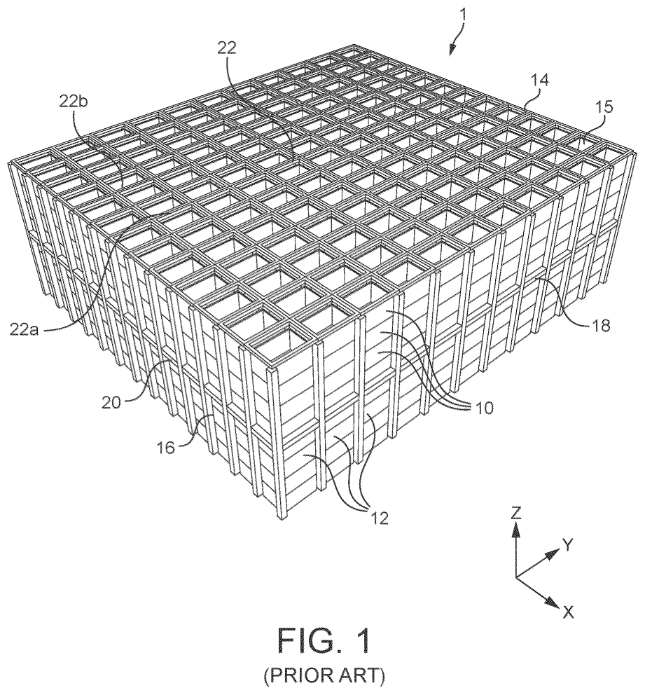

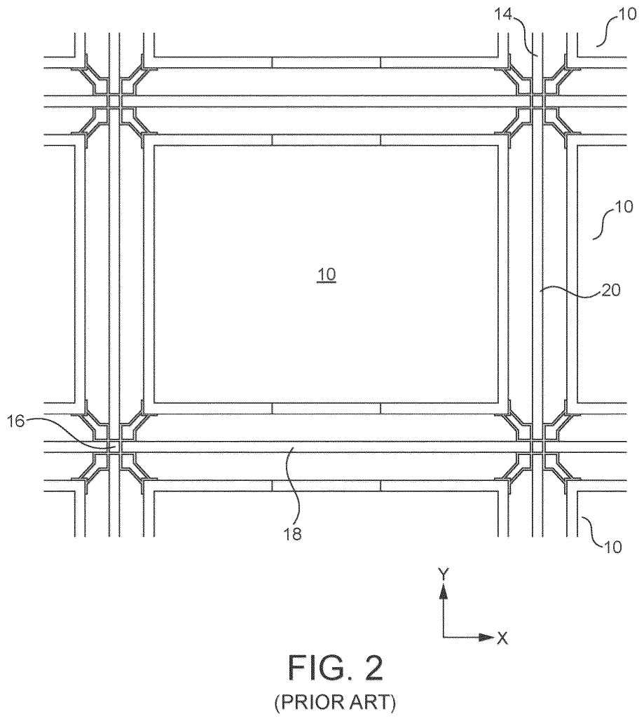

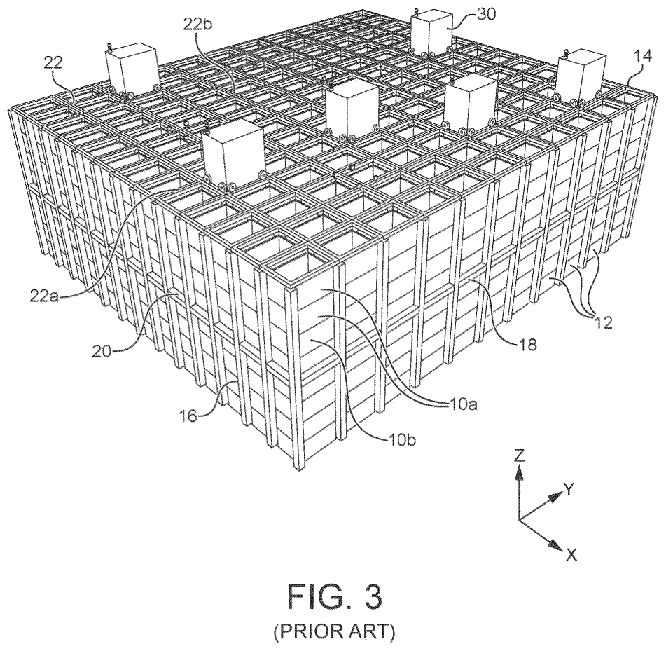

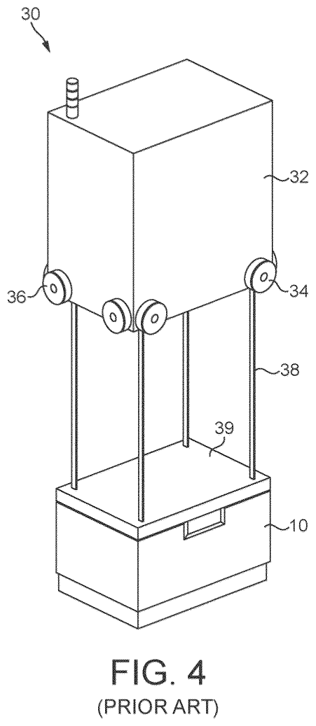

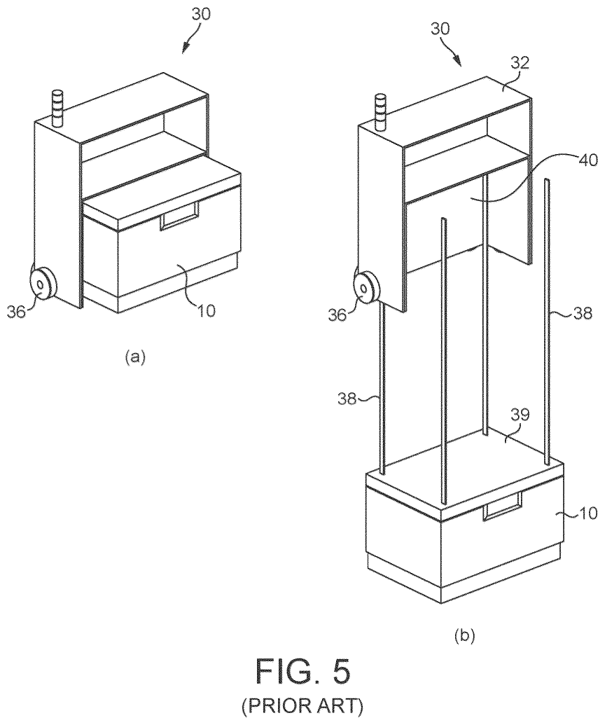

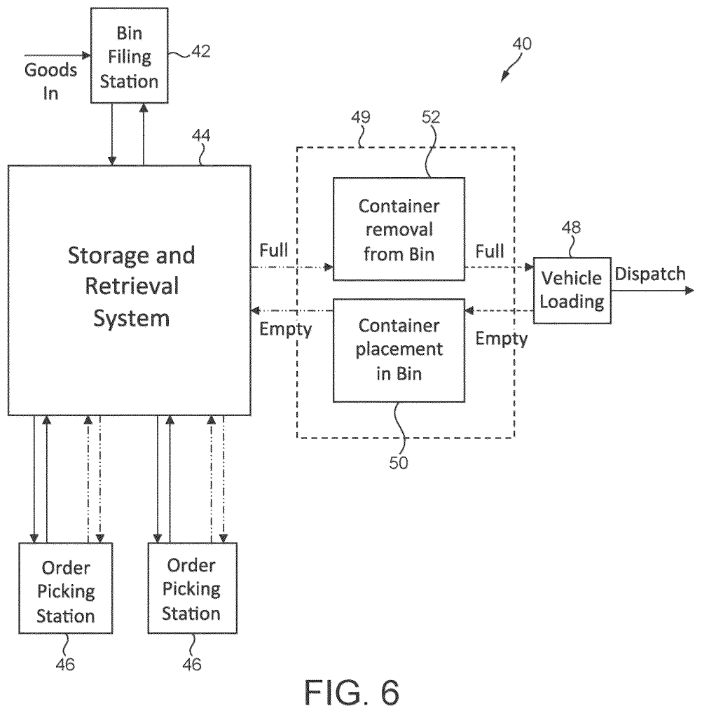

It is against the known features of the storage and retrieval system such as the grid framework structure and the load handling device described above with reference to FIGS. 1 to 5, the present invention has been devised. FIG. 6 shows a schematic flow diagram illustrating aspects of the order processing or fulfilment system 40 according to an example of the present invention. The order processing or fulfilment system 40 is shown to comprise a storage container filling station 42. For convenience, this is known as a bin filling station 42 and enables palleted goods and/or other multi-packs of inbound items to be separated and placed, individually or in groups, into separate storage containers for storage in the grid framework structure. Such re-stocking processes can be performed using any suitably configured fully or semi-automated system(s), using for example various type(s) of conveyors, trolleys, robotic devices etc., and/or can be performed manually by human workers. In various examples, re-stocking stations can include single or plural pick stations wherein one or more palletized, boxed, or otherwise packaged item sets are picked and placed into initially empty or partly filled storage containers. One or more robotic load handling device or load handling devices operative on the grid structure can be instructed to transfer the re-stocked storage container(s) from the bin filling station 42 for storage in the storage and retrieval system 44, more specifically, within a storage column in the grid framework structure. For example, a conveyor system can move the restocked storage container to a suitable location below the grid structure such that a load handling device operative on the grid structure can pick up the restocked storage container and transfer it to a storage column in the grid framework structure until required to fulfil a customer order. For the purpose of the present invention, the grid members comprises tracks or rails arranged in the grid pattern. The tracks or rails can be integrated into the grid members, e.g. by extrusion, or alternatively, secured to the grid members, e.g. by a snap-on arrangement or use of fasteners. Individual storage containers may be stacked in vertical storage columns, and their locations in the grid framework structure or “hive” may be indicated using co-ordinates in three dimensions to represent the load handling device or a container's position and a container depth (e.g. container at (X, Y, Z), depth W). Equally, locations in the grid framework structure may be indicated in two dimensions to represent the load handling device or a container's position and a container depth (e.g. container depth (e.g. container at (X, Y), depth Z). For example, Z=1 identifies the uppermost layer of the grid framework structure, i.e. the layer immediately below the rail system, Z=2 is the second layer below the rail system and so on to the lowermost, bottom layer of the grid framework structure. A majority of the grid columns in the grid framework structure are storage columns.

To fulfil a customer order, it is often necessary to retrieve items from multiple storage containers. The order processing or fulfilling system 40 additionally comprises one or more order picking stations 46. Storage containers can be retrieved from the storage and retrieval system 44 and brought to a desired order picking station 46. Specific containers required for fulfilment of orders are accessed by a load handling device operative on the grid framework structure. The load handling device preferably comprises a control unit which receives control signals from a radio communications unit of a control system or a central control system concerning information on where to pick up and deliver a storage bin or container in the grid framework structure. The control system controls the operation of one or more load handling devices operative on the grid framework structure and comprises one or more processors, a memory (e.g. read only memory and random access memory) and a communication bus. The memory can be any storage device commonly known in the art and include but are not limited to a RAM, computer readable medium, magnetic storage medium, optical storage medium or other electronic storage medium which can be used to store data and accessed by the one or more processors. Items picked to a customer order from the retrieved storage containers are placed in delivery containers. To assist with the dispatch of the picked items to a customer order, one or more carrier bags are placed inside the delivery containers such that items picked from one or more storage containers are placed inside the one or more carrier bags. When a delivery container is appropriately filled with ordered items, it can be returned from the picking station to the storage and retrieval system until ready or otherwise required for delivery to a dispatch facility 48.

To return the filled delivery container to the storage and retrieval system 44, typically, the delivery container is placed inside or nested within a storage container to form a delivery container and storage container combination. This allows the storage containers containing the delivery containers to be manipulated by a load handling device operative on the grid structure and be stacked on top of other storage containers in one or more vertical storage columns. Suitable configuration of delivery containers for such purposes, by, for example, ensuring that upper edges of the delivery containers do not protrude above the upper edges of the storage containers, when placed therein, can allow the combined delivery container and storage containers to be stored within the grid framework structure.

Returning to the flowchart shown in FIG. 6, one or more empty delivery containers can be placed inside storage containers 50 at the dispatch facility 48 or between the dispatch facility and the storage and retrieval system. For example, prior to be transferred to the order picking stations 46, one or more delivery containers may be placed within each storage container and optionally, one or more shopping or carrier bags may be placed within the delivery containers, and the resultant delivery container and storage container combination can be transferred by a load handling device operative on the grid structure to a storage column for storage in the grid framework structure until needed at an order picking station 46. When fulfilling a customer order, the combined delivery container and storage containers are retrieved from storage in the storage and retrieval system by one or more load handling devices operative on the grid structure and transferred to the order picking station 46. At the order picking station 46, delivery containers within a combination may be stocked with items picked from one or more storage containers separately retrieved from the storage and retrieval system. The region of the order or fulfilment processing system 40 for sortation of the delivery container and the storage container is defined as a container sortation system 49 (see dashed box in FIG. 6). The container sortation system 49 includes the apparatus for separating a delivery container and a storage container and combining a delivery container and a storage container. When all delivery containers associated with an order have been appropriately filled, the corresponding delivery container and storage container combination can be retrieved by the storage and retrieval system and either returned to the storage and retrieval system until a scheduled time when the delivery container is ready for dispatch at the dispatch facility or delivered to the dispatch facility 48. At the dispatch facility 48, the filled delivery containers can be removed from its combination with its storage container 52 and loaded or otherwise processed for delivery, e.g. loaded into vehicles for dispatch to a customers.

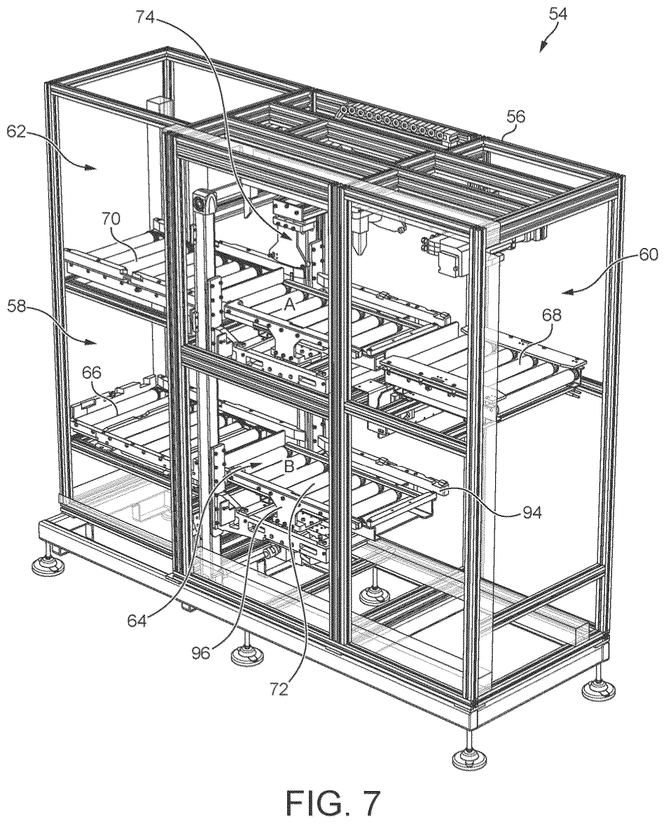

Combining the delivery containers with the storage containers by nesting the delivery container within the storage container provides the advantage that the delivery containers can be manipulated by a load handling device operative on the grid structure and thus, stored in the grid framework structure until when required for picking or dispatch at the dispatch facility. In the process of both stocking the delivery containers and transferring the delivery containers for dispatch, it is necessary that the delivery container is both combined with a storage container as well as being separated from a storage container for dispatch. The combination and separation of the delivery container and storage container can be performed by separate apparatuses, e.g. a combination apparatus for combining the delivery container and the storage container and a separation apparatus for separating the delivery container and the storage container. FIG. 7 is an example according to the present invention illustrating an apparatus 54 that can both combine and separate a delivery container and a storage container. The apparatus 54 comprises a control system that facilitate both full or semi-automated separation or combination of the delivery container and a storage containers, a frame 56 supporting a storage container station 58, a delivery container station 60, a combined station 62 and a merge/separation station 64. Each of the storage container station 58, the delivery container station 60, the combined station 62 and the merge/separation station 64 are configured for conveying a delivery container and/or storage container around the apparatus. In the particular embodiment of the present invention, each of the storage container station 58, the delivery container station 60, the combined station 62 and the merge/separation station comprises a transfer mechanism for transferring a delivery container and/or storage container around the apparatus. In the particular embodiment of the present invention, the transfer mechanism comprises at least one conveyor unit. The respective conveyor units of the storage container station 58, the delivery container station 60, the combined station 62 and the merge/separation station are orientated such that the direction of travel of the delivery container and/or the storage container within the apparatus are substantially parallel to each other.

For example, the storage container station 58 comprises a storage container conveyor unit 66 for a transporting a storage container in a first direction. The delivery container station 60 comprises a delivery container conveyor unit 68 configured for transferring a delivery container in a second direction and the combined station 62 which receives or feeds a combined delivery container and storage container to and from the merge/separation station comprises a combination conveyor unit 70 which is configured for transporting a combined delivery container and storage container in a third direction. The merge/separation station 64 comprises merge/separation conveyor unit 72 which is configured for feeding or receiving a storage container and/or delivery container to and from their respective storage container station 58, the delivery container station 60 and the combined station 62. The merge/separation conveyor unit 72 is shown in FIG. 7 in the raised position A and the lowered position B. Various types of conveyor units know to the person skilled in the art for moving a container is applicable in the present invention. For example, the conveyor unit can be belt driven. In the particular embodiment of the present invention, one or more of the conveyor units comprises one or more rollers. The rollers can be passive or can be configured to rotate by a suitable drive mechanism, e.g. belt driven mechanism, to transport a container from one station to another station in the apparatus. Where the rollers are passive, other transfer mechanisms can be used for transporting a container to and from the different stations in the apparatus. In the particular embodiment of the present invention, the delivery container is transported between the merge/separation station 64 and the delivery container station 60 by a moveable clamping device 74 that is configured to clamp the delivery container and a drive mechanism configured to transport the clamping device 74 between the merge/separation station 64 and the delivery container station 60. In other words, the transfer mechanism can convey a deliver container between the delivery container station 60 and the merge/separation station 64. Further detail of the clamping device with respect to the merge/separation station is discussed below.

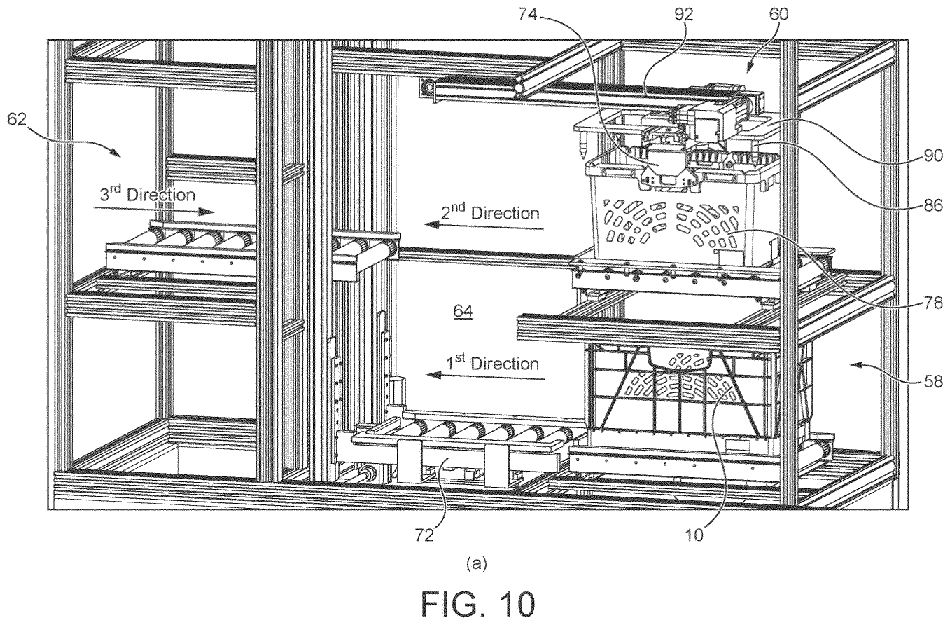

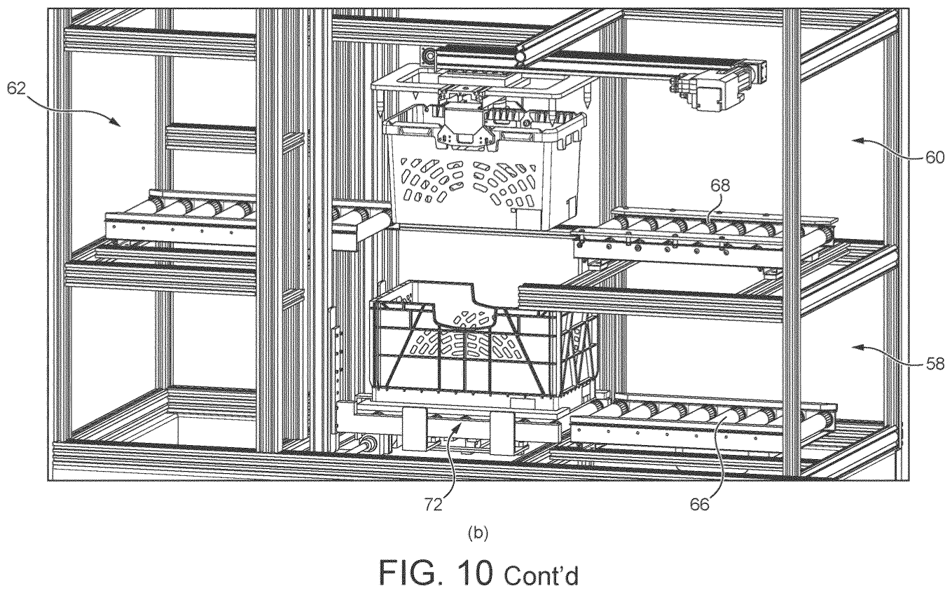

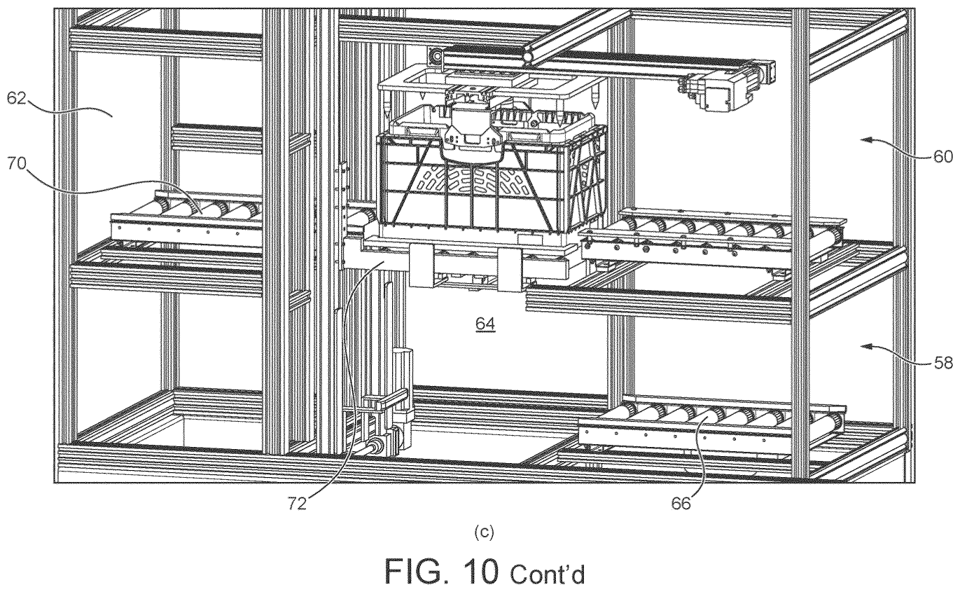

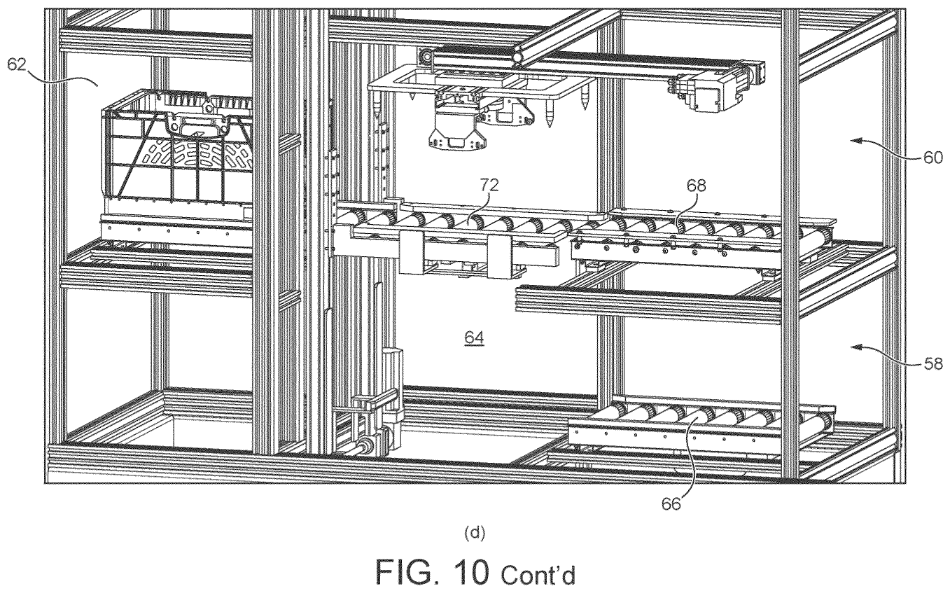

One or more of the stations are arranged in different vertical levels in the apparatus 64 such that the storage container station 58, the delivery container station 60, the combined station 62 and the merge/separation station 64 all lie in the same vertical plane. As a result, the first, second and third directions shown by the arrows in FIG. 10a are substantially parallel to each other. This provides the advantage of reducing the footprint of the apparatus. In the particular example illustrated in FIG. 10a, the first, second, and third directions are substantially horizontal. The first direction is substantially the same as the second direction, and the third direction is opposite to the first and second directions. In other examples, the apparatus may be configured differently, so the first, second, and third directions are not limited to being parallel to one another.

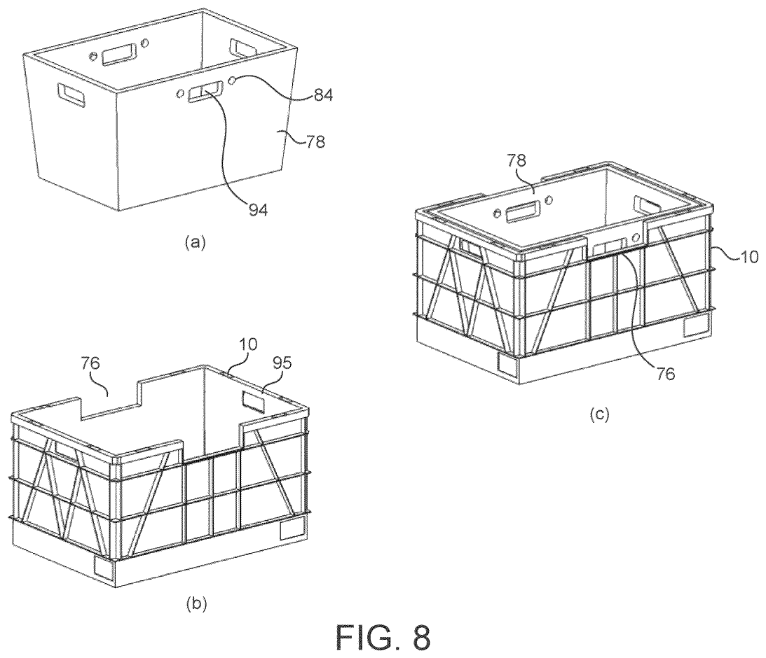

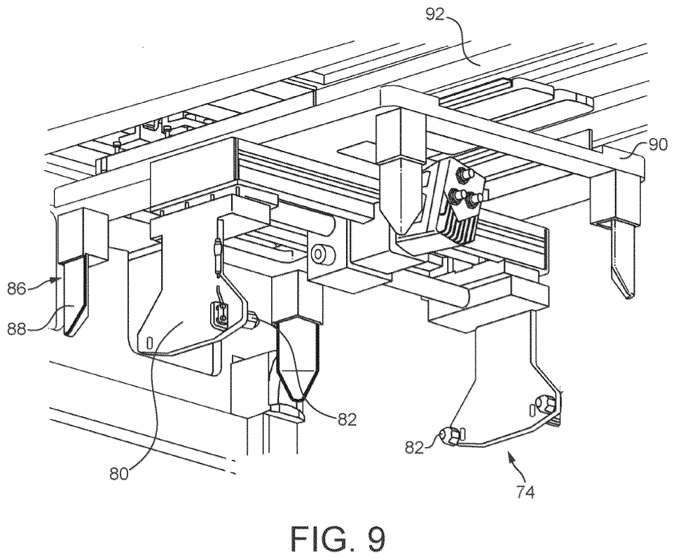

To combine and separate a delivery container and a storage container in the merge/separation station, the merge/separation station comprises a clamping device and a lifting device that is arranged to clamp the delivery container whilst the storage container is being lifted towards or away from the delivery container. To facilitate easy removal of the delivery container from the storage container, it is necessary that the delivery container is clamped by the clamping device when combined with the storage container. In one example of the present invention as shown in FIG. 8, the storage container comprises one or more cut outs 76 in at least one side wall of the storage container such that when combined with a delivery container 78 as shown in FIG. 8c (i.e. when the side walls of the storage container encircles the delivery container), the cut out 76 extends below the height of the delivery container 78. In the particular embodiment shown in FIG. 9, the clamping device 74 optionally comprises two clamps 80 that is configured to clamp opposing side walls of the delivery container through the cut out 76 of the storage container. In operation, the clamping device 74 in an open configuration is placed around the opposing side walls of the delivery container in the area where the cut out 76 of the storage container extends below the height of the delivery container 78. In the open configuration of the clamping device, the two clamps 80 move apart so as to enable the clamping device 74 to be placed around the opposing side walls of the delivery container 78. Once placed around the opposing side walls of the delivery container 78, the clamping device is instructed by the control system to clamp onto the opposing side walls of the delivery container in a closed configuration. Optionally, the clamp comprises engagement features 82 that engages with corresponding engagement features 84 in the delivery container 78 so that when clamped, the delivery container 78 is held by the clamping device 74 when it is being combined with or separated from a storage container 10. In the particular embodiment of the present invention shown in FIG. 9, the engagement features 82 of the clamping device comprises one or more pins 82 that are received in corresponding openings 84 in the delivery container 78 (see FIG. 8a) when the clamping device clamps onto the sidewall of the delivery container.

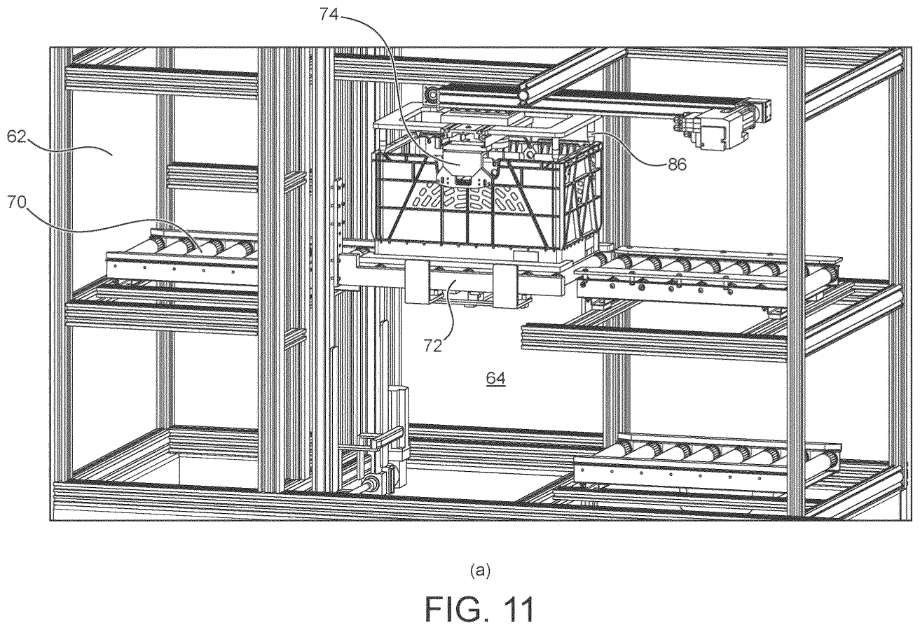

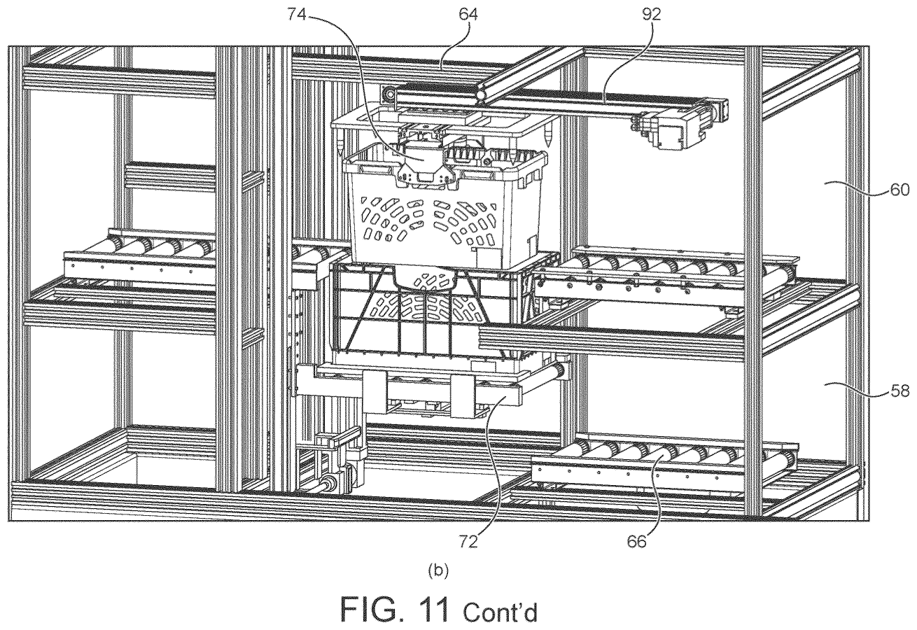

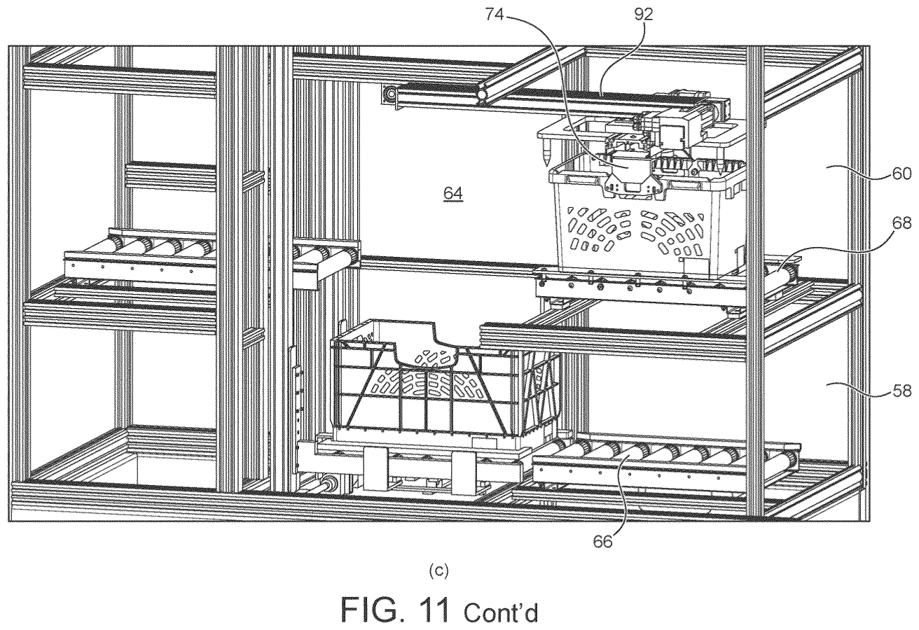

In order for the pins 82 of the clamping device 74 to be received in the openings 84 in the delivery container 78 when combined with the storage container, it is essential that the pins 82 are correctly aligned with the corresponding openings 84 in the delivery container 78. To correctly position the delivery container 78 relative to the clamps 80, the merge/separation station 64 further comprises an alignment mechanism 86 that is configured to engage with at least one exterior or interior wall of the delivery container 78 to position the delivery container 78 relative to the clamps 80. In an exemplary embodiment of the present invention, the clamping device is arranged to clamp the delivery container when the delivery container is centred with respect to the walls of the storage container. To centre the clamps, the alignment mechanism comprises a centring device comprising one or more guides that are arranged to engage or interact with the delivery container when nested within the storage container. In the particular embodiment of the present invention, the centring device comprises a plurality of locating pins or guides 88 that are configured to engage with diagonally opposed corners of the delivery container 78. Four locating pins 88 are shown configured to engage with the corners of the delivery container (see FIG. 11(a)). When engaged with the delivery container 78, the locating pins 88 guides the delivery container centrally relative to the storage container and therefore, guides the delivery container into the correct position relative to the clamps of the clamping device 74. The one or more guides of the centring device are such that if the delivery container is off centre with respect to the storage container, the one or more guides interacts with the walls of the delivery container and re-positions the delivery container within the storage container so as to enable the clamping device to clamp onto the delivery container nested within the storage container. To guide the delivery container into the correct position, at least a portion of each of the locating pins 88 is wedge shaped or have an inclined guiding surface such that when engaged with the corners of the delivery container, the delivery container is moved into the correct position thereby, ensuring that the openings 84 in the at least one side wall of the delivery container is aligned with the engagement pins 82 of the clamp 80. In the particular embodiment shown in FIG. 9, the clamping device 74 and the alignment mechanism 86 is supported on a frame 90 such that the alignment mechanism 86 and the clamping device 74 cooperate with each other to facilitate clamping of the delivery container. The lifting mechanism is arranged to lift the delivery container into engagement with the alignment mechanism 86 (see FIG. 11(a)). Further detail of the process of engagement of the delivery container with the alignment mechanism so as to facilitate clamping of the delivery container and removal or insertion into a storage container is discussed further below with reference to FIG. 10 (a to d) and FIG. 11(a to c) below. FIG. 10(d) shows a combined delivery container and storage container in the combined station which is shared between FIGS. 10 and 11.

In contrast to the transfer mechanism being the conveyor unit to transport a storage container and/or combined delivery container and storage container to and from the merge/separation station, in the case of the delivery container station, the transfer mechanism is arranged to move the clamping device between the merge/separation station and the delivery station. The frame 90 supporting the clamping device 74 and the alignment mechanism 86 is moveably mounted to a substantially horizontal rail or track 92 extending between the delivery station 60 and the merge/separation station 64 and guides the frame 90 sideways between the merge/separation station and the delivery station. A drive mechanism is arranged to move the frame 90 supporting the clamping device 74 between the merge/separation station and the delivery station. In this case, the delivery conveyor unit 68, in particular the rollers are passive, i.e. freely rotating such that the transfer mechanism is configured to move a delivery container on the passive rollers of the delivery container conveyor unit 68. The drive mechanism can be belt drive or hydraulic drive. In the particular embodiment of the present invention, the frame 90 is driven sideways by a belt driven mechanism. However, other transfer mechanisms known in the art for conveying a container between different stations are applicable in the present invention. For example, the conveyor unit itself can have an integrated drive mechanism to move a container. Different combinations of the transfer mechanism for transporting delivery container and/or storage containers between the different stations in the apparatus is applicable in the present invention. For example, the delivery container conveyor unit 68 need not necessarily be passive and can be configured to transport the delivery container between the delivery container station 60 and the merge/separation station 64. Equally, plausible in the present invention is that the transfer mechanism can comprise a clamping device moveably mounted to a track or rail that is arranged to transport a delivery container and/or the storage container between the merge/separation station and the different stations in the apparatus.

Also shown in FIG. 8, is that the delivery container 78 optionally comprises one or more handles 95 which can be engaged by one or more merging/separation mechanisms for placing or removing the delivery container into/from a storage container. This mechanism may be used alternatively or in addition to the one or more openings 84 in the side wall of the delivery container 78 to facilitate removal of the delivery container from the storage container. For example, the one or more handles can also facilitate manual removal of the delivery container from the storage container.

FIG. 10(a to d) shows the different stages in combining a delivery container 78 with a storage container 10 in the combination and separation apparatus according to the present invention. The process starts with the clamping device 74 moving sideways to the delivery container station 60 to pick up a delivery container 78 as shown in FIG. 10a. Concurrently or subsequently, a storage container 10 in fed into the merge/separation station 64 by the storage conveyor unit. In the particular embodiment shown in FIG. 10a, the storage container is transferred to the merge/separation station 64 via the storage container conveyor unit. However, other transfer mechanisms for conveying the storage container to the merge/separation station is applicable in the present invention. For example, a clamping device can be configured to transfer the storage container between the storage container station and the merge/separation station 64. Using the terminology discussed above, the storage container is fed into the merge/separation station 64 in the first direction and the delivery container is fed into the merge/separation station 64 in the second direction. The storage container is fed onto a merge conveyor unit in the merge/separation station. In the particular embodiment of the present invention, the merge conveyor unit is configured to travel vertically by the lifting mechanism from a lowered position as shown in FIG. 10b to a raised position as shown in FIG. 10c. To combine the storage container with the delivery container suspended above the merge conveyor unit, the storage container is lifted by the lifting mechanism until the delivery container is inserted within the storage container as shown in FIG. 10c. Other means to combine the delivery container with the storage container include but is not limited to lowering the delivery container towards the storage container. Here, the delivery container clamped by the clamping device is lowered by lowering the clamping device towards the merge conveyor unit 72. This could involve the use of tethers for suspending the clamping device and a pulley mechanism driven by the lifting mechanism to raise and lower the clamping device and thus, the delivery container relative to the storage container.

To prevent the storage container crashing into the delivery container when being lifted or lowered towards the storage container, the merge conveyor unit further comprises a datum edge 94 which represents a reference point on the merge/separation conveyor station 72 such that when an edge of the storage container is positioned against the datum edge 94, the open end of the storage container is directly below the delivery container. To position an edge of the storage container against the datum edge 94, the merge conveyor unit 72 further comprises a datum clamp 96 that is configured to clamp the storage container on the merge conveyor unit against the datum edge 94 (see FIG. 7).

Once combined, the combined delivery container and storage container is transferred into the combined station 62 via the combination conveyor unit 70 for subsequent dispatch at the dispatch facility. The merge/separation station 64 is interposed between the delivery container station 60 and the storage container station 58 such that in the raised position of the merge station conveyor unit 72, the merge conveyor unit 72, the delivery container conveyor unit 68 and the combination conveyor unit 70 are all on the same level to form a continuous conveying system as shown in FIG. 10d. As a result, movements of the storage container and the delivery container between the different stations in the apparatus are substantially parallel to each other.

The same apparatus can be used to separate the delivery container and the storage container. Starting with the combined delivery container and storage container at the combined station 62 shown in FIG. 10d, the different stages in separating a combined delivery container and storage container are shown in FIGS. 11a, 11b and 11c. The process begins with the combination conveyor unit 70 in the combined station 62 transferring the combined delivery container and storage container towards the merge/separation station 64 as shown in FIG. 11a. When being transferred to the merge/separation station 64, the clamping device 74 is in the open configuration so as to allow the combined delivery container and storage container to be transferred onto the merge conveyor unit 72 in the raised position. Once on the merge conveyor unit 72 and prior to the clamping device 74 clamping against the at least one side wall of the delivery container through the cut-out 76 in the storage container 10, the combined delivery container and storage container is lifted into engagement with the alignment mechanism 86 to correctly position the delivery container into alignment with the clamps of the clamping device 74, more specifically into engagement with the one or more pins 82 of the clamps as discussed above. Once the delivery container is correctly positioned relative to the clamping device 74, the lifting device lowers the merge conveyor unit 72 to disengage the combined delivery container and storage container from the alignment mechanism 86 but sufficient for the one or more pins of the clamps to be received in the corresponding openings in the delivery container when the clamping device returns to the closed configuration so as to enable the clamps to grip the delivery container as shown in FIG. 11b. Once the delivery container is secured by the clamps, the lifting device lowers the merge/separation conveyor unit 72 to separate the storage container from the delivery container. Once in the lowered position, the empty storage container is transported to the storage container station 58. The delivery container clamped by the clamping device is transported to the delivery container station and the arrangement of the delivery container and the storage container is similar to the arrangement shown in FIG. 10a.

The ability of the apparatus to interchangeably be used as a combination apparatus and a separation apparatus permits one (first) apparatus to as function as a separation apparatus and another (second) apparatus to function as a combination apparatus. This allows an empty storage container separated from a first apparatus to be fed into the second apparatus to be subsequently combined with a fresh delivery container. Referring to an order processing or fulfilment system 40 shown in FIG. 6, a combined delivery container and storage container stored in the storage and retrieval system 44 can be fed into a first apparatus configured for separating the delivery container containing a customer order and a storage container. The separated delivery container is fed to a dispatch facility via a conveyor system for dispatch to a customer. The empty storage container is recycled to the second apparatus whereupon the empty storage container is combined with a fresh delivery container delivered by a separate conveyor system to be stored in the storage and retrieval system 44 until needed at an order picking station 46. For ease of explanation, the combination of the first and second apparatus is termed a container sortation apparatus 49. The container sortation apparatus forms parts of the order or fulfilment system 40 discussed above with reference to FIG. 6.

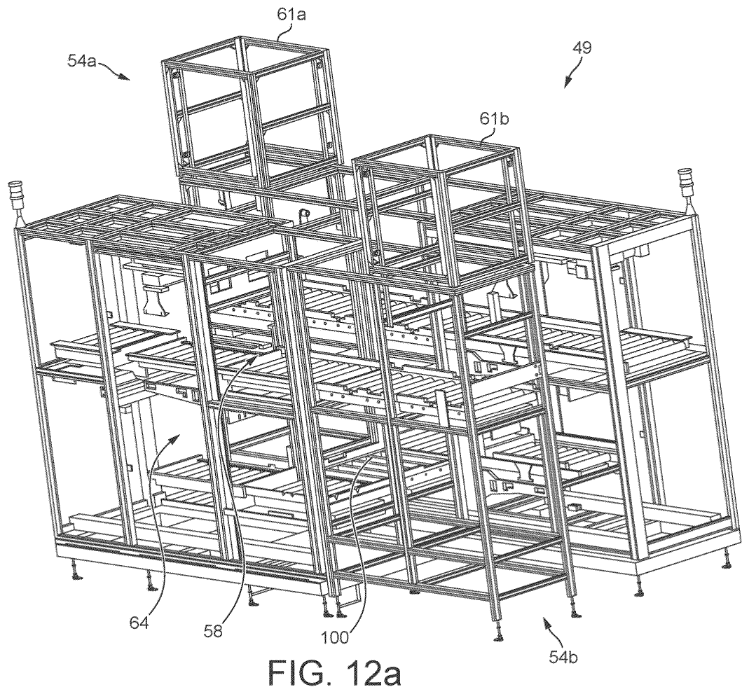

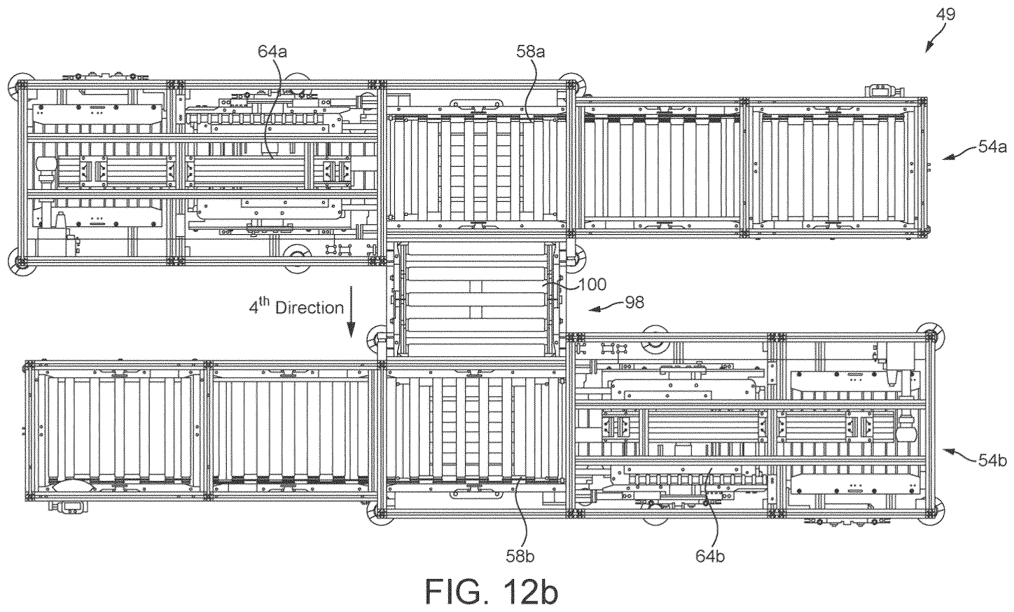

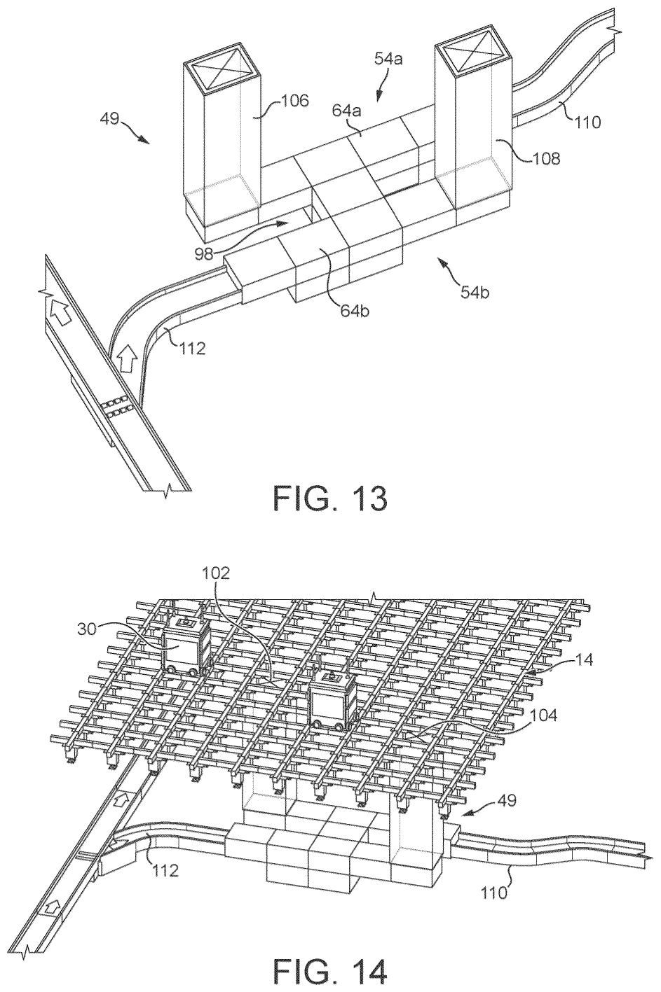

FIG. 12a is a schematic drawing of a perspective view of the container sortation apparatus 49 and FIG. 12b is a top plan view of the container sortation apparatus. To enable the first apparatus 54a to function as a combination apparatus and the second apparatus 54b to function as a separation apparatus, the first apparatus 54a is rotated substantially 180° with respect to the second apparatus 54b such that their respective delivery container stations 60a, 60b and their respective merge/separation stations 64a, 64b are not directly opposite each other. This is shown in FIG. 13, where the combined delivery container and storage container are separated at the separation station 64a and the separated storage container from the first apparatus 54a is combined with a fresh delivery container at the combination station 64b. This also allows the merge/separation station of the first apparatus 54a to receive a separated delivery container in one direction to the dispatch facility and the merge/separation station of the second apparatus 54b to feed a combined delivery container and storage container in the same parallel direction to be taken away to the storage and retrieval system. A bridge 98 links the first apparatus 54a to the second apparatus 54b such that an empty storage container separated from the first apparatus 54a is transported to the second apparatus 54b to be combined with a fresh delivery container in the second apparatus 54b. The bridge 98 comprises a bridge conveyor unit 100 for feeding the empty storage container from the first apparatus 54a to the second apparatus 54b along a fourth direction (see arrow in FIG. 12b). In the particular embodiment shown in FIG. 12a, the bridge conveyor unit 100 bridges the storage container station 58a of the first apparatus 54a with the storage container station 58b of the second apparatus 54b, i.e. the first and second apparatuses are rotated about their respective storage container stations such that their respective storage container stations are directly opposite each other. To provide a substantially compact container sortation apparatus 49, the fourth direction is substantially perpendicular to the first, second and third directions.

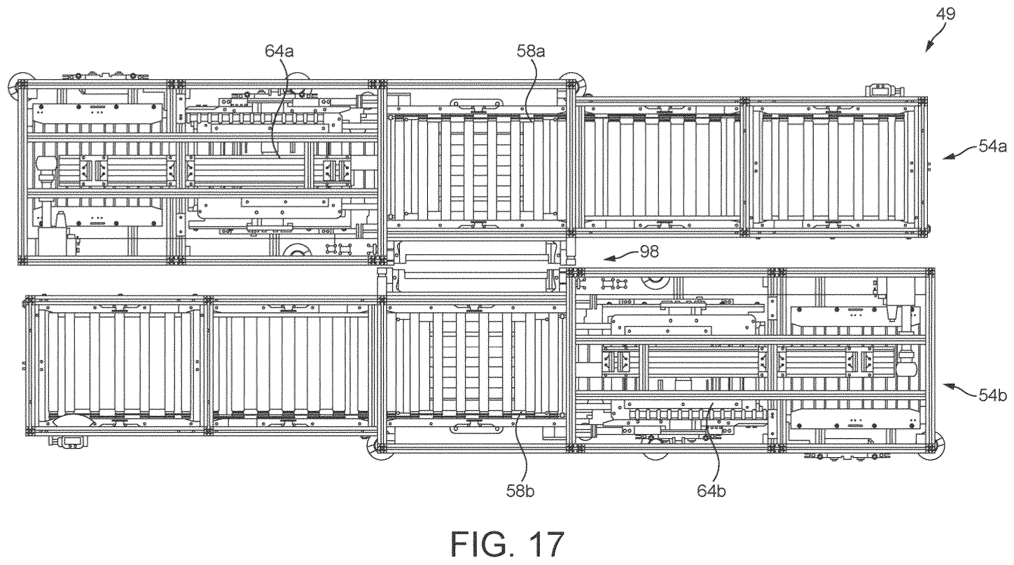

FIG. 17 illustrates atop plan view of another embodiment of the container sortation apparatus 49. Like the container sortation apparatus 49 illustrated in FIG. 12b, the first apparatus 54a functions as a combination apparatus and the second apparatus 54b functions as a separation apparatus, and the first apparatus 54a is rotated substantially 180° with respect to the second apparatus 54b. The storage container stations 58a and 58b of the first and second apparatus respectively are opposite each other, and the respective delivery container stations 60a, 60b and respective merge/separation stations 64a, 64b are not directly opposite each other. Unlike the embodiment illustrated in FIG. 12b, however, the container sortation apparatus 49 does not have a bridge conveyor unit 100. The bridge 98 does not comprise a bridge conveyor unit 100, but instead provides a direct route for an empty storage container 10 to be transferred from the storage container station 58a of the first apparatus 54a directly to the storage container station 58b of the second apparatus 58b, ready to be combined with a fresh delivery container at the combination station 64b of the second apparatus. The absence of a bridge conveyor 100 in the bridge 98 means that the embodiment of the container sortation apparatus 49 illustrated in FIG. 17 is more compact than that of the embodiment illustrated in FIG. 12b. As well as the space saving, the complexity and part count of the container sortation apparatus 49 is reduced, with a resulting saving in costs, materials, and manufacturing time.

Also shown in FIG. 12a is an inbound region 61a of the first apparatus 54a where a combined delivery container and storage container is fed into the merge/separation apparatus of the first apparatus and an outbound region 61b of the second apparatus where a combined delivery container and storage container is taken away from the second apparatus. The container sortation apparatus 49 is able to be integrated into the storage and retrieval system such that the grid structure extends across the first and second apparatuses. Thus, a load handling device 30 operative on the grid structure is able to transport a combined delivery container and storage container to and from the first and second apparatuses (see FIG. 14). The grid structure extending across the first and second apparatuses comprises a drop-off port 102 through which the load handling device 30 can drop-off a combined delivery container and storage container and a pick-up port 104 through which a load handling device 30 operative on the grid structure can pick-up a combined delivery container and storage container. The grid column in which the drop-off port 102 is located is defined as a delivery port column 106 and the grid column in which the pick-up port 104 is located is defined as a pick-up port column 108 (see FIG. 13). The combined delivery container and storage containers are fed into the first apparatus via the delivery port column 106 and the combined delivery container and storage containers are picked up from the second apparatus via the pick-up port column 108. In the particular embodiment of the present invention shown in FIGS. 13 and 14, the drop-off port column and/or the pick-up port column comprises a chute, i.e. a delivery chute and pick-up chute, that cooperate with the grid structure above to enable a robotic load handling device 30 operative on the grid structure to drop-off a combined delivery container and storage container to the first apparatus via the delivery chute 106 and a robotic load handling device operative on the grid structure can pick-up a combined delivery container and storage container from the second apparatus via the pick-up chute 108. The delivery chute and/or pick-up chute extends from the grid structure to the first and/or second apparatuses such that a robotic load handling device operative on the grid structure can be instructed to pick-up or lower a combined delivery container and storage container using its own lifting mechanism. As discussed above, the delivery container is nested within the storage container such that the sidewalls of the delivery container does not extend above the height of the storage container so as to permit the lifting mechanism comprising the grabber device of the robotic load handling device 30 to engage with the storage container combined with the delivery container. The delivery chute and/or the pick-up chute can comprise at least two vertical guides for guiding the combined delivery container and storage container vertically along their respective chute. The separated delivery container exiting the first apparatus 54a is fed to the dispatch facility via a conveyor system 110. Additionally, a separate conveyor system 112 can transport a delivery container to be combined with a storage container in the merge/separation station of the second apparatus to be subsequently picked up through the pick-up port column (see FIG. 14).

Optionally, the delivery port column 106 and/or the pick-up port column 108 can each comprise at least one bin lift device (not shown) that is operative to lift or lower a combined storage container and delivery container at least partially along the height of the delivery port column and/or the pick-up port column. The least one bin lift device can be mechanically driven to lift or lower a combined delivery container and storage container vertically along their respective delivery port column and/or pick-up port column. Although not shown in FIGS. 13 and 14, the at least one bin lift device can comprise at least one lifting arm that is configured to engage with at least one side wall and/or bottom wall of the storage container and a lifting mechanism, e.g. a belt driven mechanism, to drive the lifting arm in a vertical direction along the respective port column. The at least one bin lift device can be arranged to lift the combined delivery container and storage container vertically from a lowermost position on the conveyor unit of the container sortation apparatus 49 to an uppermost level at the grid structure wherein a load handling device operative on the grid structure can pick-up the combined delivery container and storage container at the uppermost level from the pick-up port. Similarly, a load handling device operative on the grid structure can be instructed to drop-off a combined delivery container and storage container at a drop-off port, wherein the at least one bin lift device can be arranged to lower a combined delivery container and storage container vertically from an uppermost level at the grid structure to a lowermost level on a conveyor unit of the container sortation apparatus 49. Alternatively, the at least one bin lift device can be configured to lift or lower a combined delivery container and storage container to the uppermost level anywhere between the grid structure and the conveyor unit of the container sortation apparatus 49, e.g. half way between the grid structure and the conveyor unit, and the remaining vertical distance can be covered by the lifting mechanism of the load handling device operative on the grid structure. More specially, a grabber device of the load handling device is able to grab the storage bin or container at the uppermost level and lift the storage bin or container into a container receiving space of the load handling device. Equally, the lifting mechanism of the load handling device can be instructed to lower a combined delivery container and storage container partially along the delivery port column to be carried by the bin lift device to the lowermost position to the combined station of the first apparatus. Similarly, the bin lift device in the pick-up port column can be arranged to lift a combined delivery container and storage container partially along the pick-up port column from the second apparatus and the lifting mechanism of a load handling device operative on the grid structure can be instructed to carry the combined delivery container and storage container the remaining distance to the uppermost level at the grid structure to be subsequently taken away for storage in the storage and retrieval system. The advantage of the at least one bin lift is that it allows one or more combined delivery container and storage containers to be vertically accumulated in their respective delivery port column and/or pick-up port column and therefore, provides a buffer for one or more combined delivery container and storage containers to be temporarily held in their respective delivery port column and/or pick-up port column until a robotic load handling device operative on the grid structure is ready to drop-off or pick-up the combined delivery container and storage container. Moreover, the speed of travel of a storage container or a combined storage container and delivery container vertically along the delivery port column and/or the pick-up port column is very much dependent on the speed of the at least one bin lifting device. In comparison to the lifting mechanism of the load handling device, the at least one bin lifting device can be configured to lower and raise a combined storage container and delivery container to and from the grid structure and the combined and separation apparatus much faster than the lifting mechanism of the load handling device. This is particularly important where the height of the delivery port column and the pick-up port is relatively high, e.g. in excess of ten storage containers high, where height of each storage container is 36.2 cm.

In a typical operation of the order processing system, a combined “full” delivery container and storage container is lowered to the first apparatus 54a via the drop-off port column 106. The “full” delivery container represents a delivery container containing items picked from the order picking station for fulfilling a customer order. The merge/separation apparatus separates the “full” delivery container and the “full” delivery container is fed to the dispatch facility via the conveyor system 110. The separated empty storage container from the first apparatus 54a is fed to the second apparatus via the bridge 100 to be combined with an “empty” delivery container fed into the second apparatus 54b via the conveyor system 112. The combined delivery container and storage container is taken away from the second apparatus 54b to be stored in the storage and retrieval system via the pick-up port column 108 until required to be transported to the order picking station to fulfil a customer order.

The combination and separation apparatus shown in FIG. 7 can be integrated into the storage and retrieval system as a standalone apparatus such that a load handling device operative on the grid structure can drop-off and/or pick-up a storage container to be combined with a delivery container in the merger/separation station. In addition to separating a combined delivery container and storage container for dispatch to the dispatch facility, separation of the delivery container and the storage container can be used as a means to identify a delivery container nested within the storage container. For example, one or more readers, e.g. barcode readers, mounted in the merge/separation station can be configured to read a barcode on the delivery container when separated from a storage container, i.e. when the merge/separation conveyor unit lowers. This assists with the sortation of the delivery containers in the storage and retrieval system.

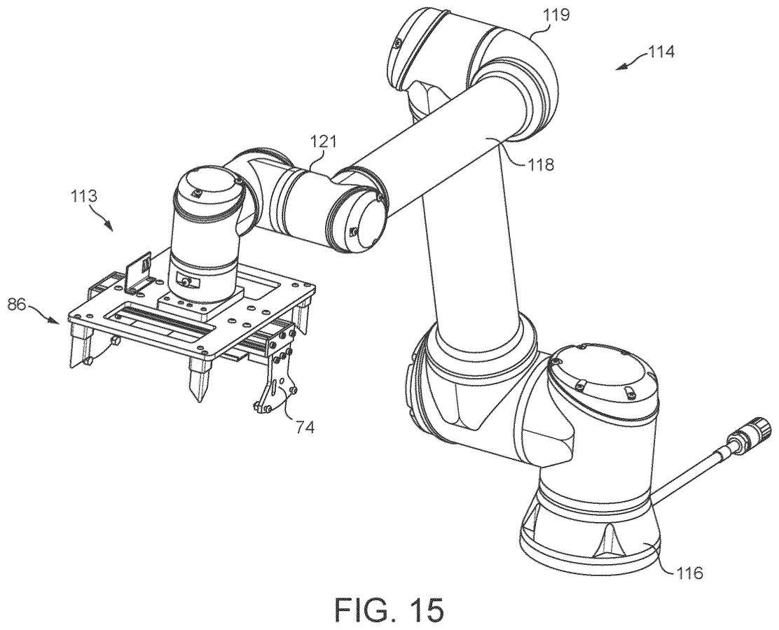

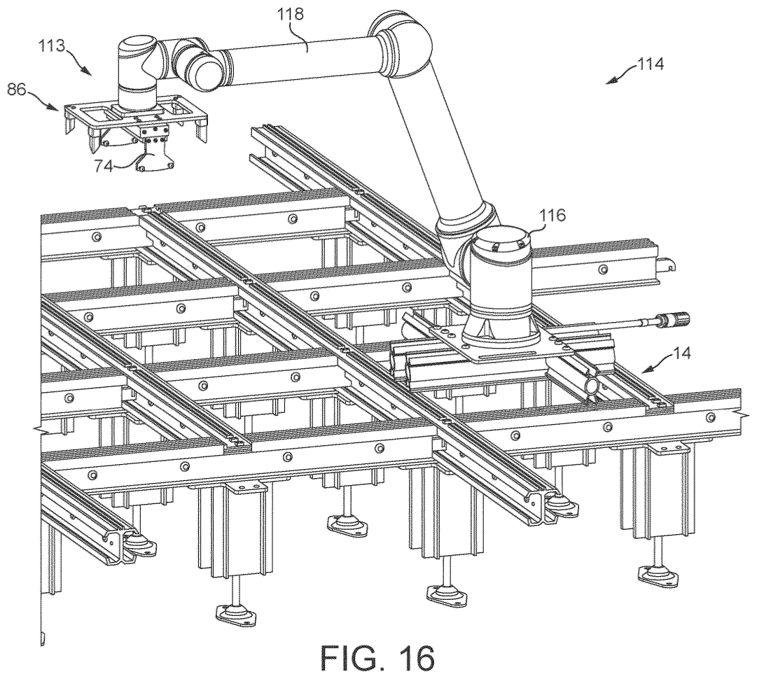

In another aspect of the present invention, the clamping device 74 and the alignment mechanism 86 comprising the centring device can function as an end effector 113 coupled to a robot arm 118 of a robot 114 as shown in FIGS. 15 and 16. In FIG. 16, the robot 114 has a robot base 116 for mounting to a grid cell of a grid structure. This allows the end effector 113 according to the present invention to combine and separate a delivery container and storage container on the surface of the grid structure and thereby, removes the need to transport the combined delivery container and storage container to an external combination and separation apparatus via a drop-off port 102 in the grid structure discussed above. Optionally, the combined delivery container and storage container can be transported to a standalone combination and separation apparatus comprising the robot 114 as shown in FIG. 15 via the drop-off port 102 in the grid structure. At the combination and separation apparatus, the robot arm 118 can be instructed to combine and/or separate a delivery container and a storage container by a process similar to the combination/separation process discussed above but rather using the lifting mechanism of the robot arm instead of the merge/separation conveyor unit 72.

In this embodiment, the clamping device 74 and the alignment mechanism 86 comprising the centring device are mounted to the robot arm 118 via a frame 90 to define the end effector 113. The process of centring the delivery container relative to the storage container and/or frame 90 by the centring device discussed above comprising the one or more guides 88 for engaging or interacting with the external surface of the delivery container still applies. The movement of the robot arm 118 and the clamping device 74 is controlled by a control system. Using the same operation as the lifting mechanism in the merge/separation station discussed above, the control system is configured to control the movement of the robot arm 118 and thus, the end effector 113 such that the one or more guides 88 of the centring device engages or interacts with the external surface of the delivery container. Once the guides interacts with the delivery container, the process of centring the delivery container relative to the storage container and/or frame in order for the clamping device to clamp onto the delivery container nested within the storage container discussed above in the merge/separation station repeats, i.e. the pair of clamps of the clamping device is positioned to clamp the opposing walls of the delivery container through the cut-outs in the storage container.

To provide multiple degrees of freedom of movement of the robot arm and thus, the end effector, the robot arm comprises a plurality moveable segments connected together by a plurality of pivotable joints, each of the plurality of pivotable joints providing rotation of the segments about one or more predetermined rotational axes, e.g. rotation about an axis along the arm (roll joint) and rotation about an axis transverse to the arm (pitch joint). In the particular embodiment of the present invention shown in FIGS. 15 and 16, the robot arm 118 comprise upper and lower segments pivotally connected together by a robot elbow 119 to provide both roll and pitch joints between the lower and upper segments. The end effector is rotatably connected to the distal end of the upper segment of the robot arm to define a robot wrist 121. The robot wrist provides rotation about an axis along the upper segment of the robot arm and transverse to the robot arm. The pivotable joint connecting the upper and lower segments of the robot arm and the robot wrist connecting the end effector provides six degrees of freedom of movement of the end effector. This allows the robot to accurately position the end effector into engagement with the delivery container.

One or more pressure sensors can be mounted on the clamps in order to provide a signal to the control system of engagement with the walls of the delivery container. Once clamped, the control system is then able to cause the robot arm 118 to lift the delivery container out of the storage container so as to separate the delivery container from the storage container. The separated delivery container can subsequently be placed on a conveyor to be transported to the dispatch area for dispatch into delivery vehicles. Alternatively, the separated delivery container can be loaded into a delivery vehicle for dispatch. The reverse is applicable when combining a delivery container and storage container. To combine the delivery container with the storage container, the control system is instructed to move the robot arm 118 such that the end effector 113 engages or interacts with the delivery container. The one or more guides 88 of the centring device centres the delivery container relative to the storage container and/or frame 90 so as to enable the clamping device 74 to clamp the delivery container. The robot arm 118 can then be instructed to pick up the delivery container and move the delivery container towards an empty storage container, where it can subsequently lower the delivery container into the mouth of the storage container. Once the delivery container is positioned into the storage container, the clamping device can release so combining the delivery container with the storage container. One or more position sensors can be mounted to the frame of the end effector to provide a signal to the control system once the delivery container is combined with the storage container

In the case where the robot 114 is mounted to a grid cell via the robot base 116 shown in FIG. 16, the operation involves instructing movement of the robot arm 118 such that the end effector 113 coupled to the robot arm 118 enters a grid cell comprising a combined delivery container and storage container. One or more grid cell guides can be mounted to the frame 90 of the end effector 113 supporting the clamping device 74 and the centring device so as to guide the end effector into the grid cell. The one or more grid cell guides can comprise wedge shape pins that interact with the inner surface of the grid cell. Once the end effector has entered the grid cell comprising the combined delivery container and storage container, the process of separating the delivery container from the storage container discussed above in the merge/separation station repeats.

The combination and separation apparatus may also include a camera mounted to the robot arm for viewing the area in which the end effector will operate. The camera may include any suitable camera or cameras, such as one or more infrared cameras, and may include a 3-dimensional depth camera. The camera may be provided with lighting elements to illuminate the interior of the grid cell when combining or separating a delivery container and storage container. Images from the camera are fed to the control system where the images are processed so as to assist in the identification and/or clamping the delivery container nested within the storage container. For example, the camera can identify the areas of the delivery container exposed by the cut outs in the storage container walls so as to enable to the clamping device to correctly position the clamps onto the walls of the delivery container. The use of a camera mounted to the robot arm or frame of the end effector to guide and position the clamping device on the delivery container may remove the need to have the centring device comprising the guides 88 to centre the delivery container relative to the storage container as the alignment mechanism can simply be provided by the camera.

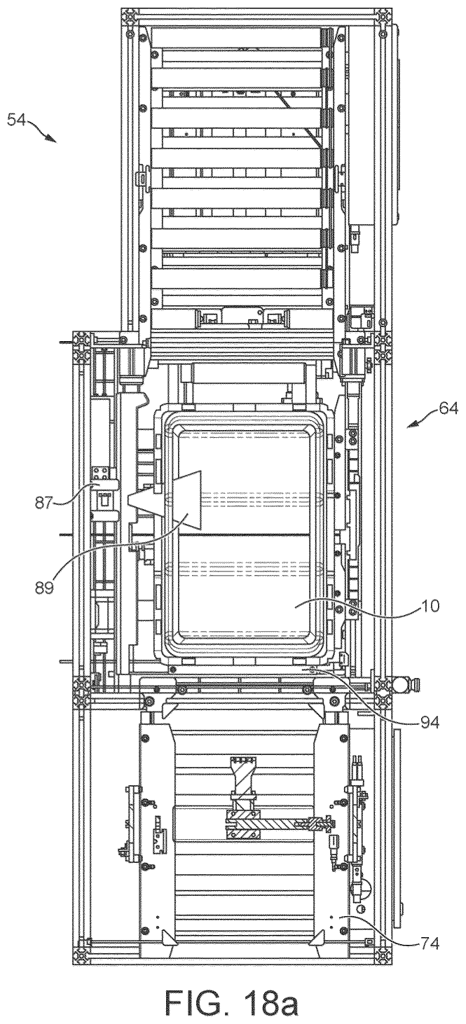

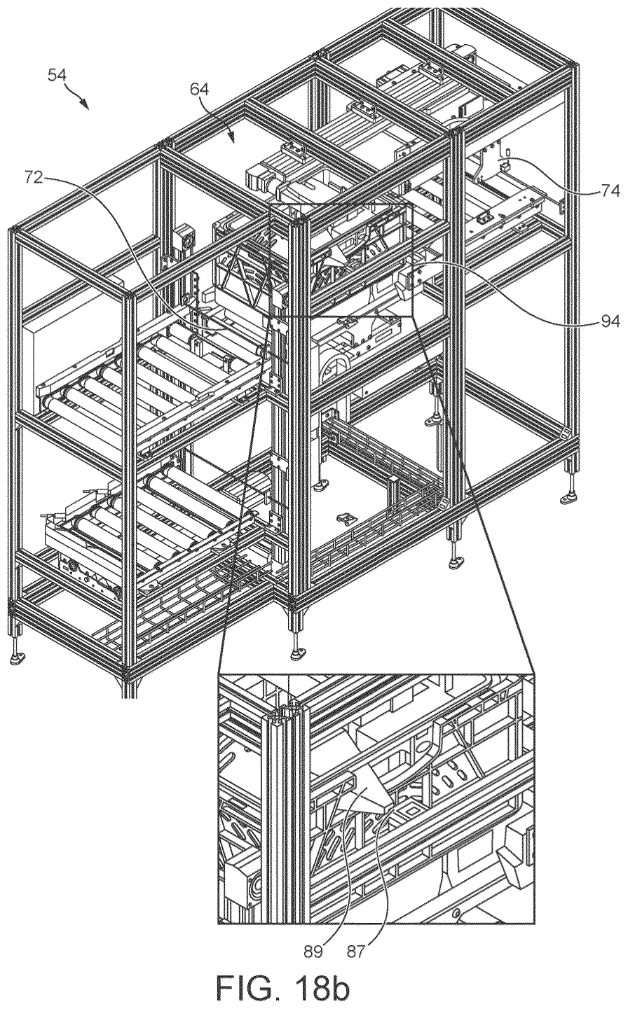

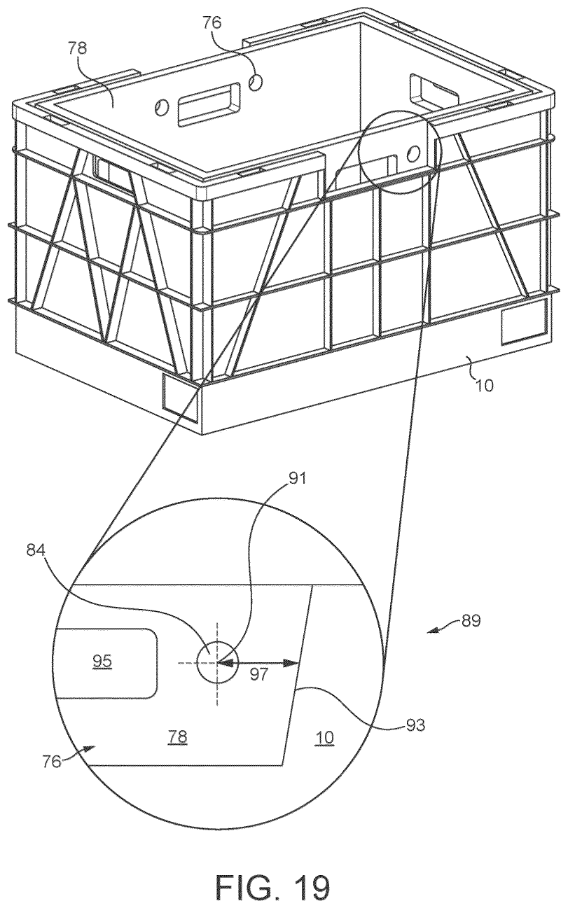

An illustrative embodiment of a vision system for separation of a storage container 10 from a delivery container 78 is shown in FIGS. 18a (top view) and 18b (perspective view). The vision system is another example of an alignment system, and can be used as an alternative or in addition to the locating pins or guides 88 described earlier. The vision system helps to determine the relative alignment of a delivery container 78 within a storage container 10, in order to position the clamping device 74 correctly on the delivery container 78 to separate the delivery container 78 from the storage container 10 at the merge/separation station 64. The vision system in FIGS. 18 and 19 is applied to an apparatus 54 that can both combine and separate a delivery container 78 and a storage container 10, but could equally be applied to the separation apparatus 54b of a combined container sortation apparatus 49 as described above, or to an end effector comprising an alignment mechanism and clamping device mounted to a robot arm as shown in FIG. 15.

In the illustrated example, the apparatus 54 comprises a merge/separation station with a combined storage tote 10 and delivery tote 78. The next stage in the process is for the delivery container 78 to be grasped by the clamp and lifted out of the storage container 10, as described in detail earlier. A camera 87 is fixed in a position facing the combined storage container 10 and delivery container 78, such that the field of view 89 of the camera 87 includes a part of both the storage container 10 and the delivery container 78. The storage container 10 and the delivery container 78 can be distinguished by the camera, for example by being different colours. The camera is positioned such that the cut-out 76 of the storage container 10 can be seen, and the side of the delivery container 78 can be seen through the cut-out 76 in the storage container 10. The part of the side of the delivery container 78 that can be seen through the cut-out 76 includes one of the openings/engagement features 84. The camera locates the position of the opening 84 within the cut-out 76, and measures the distance between the opening 84 in the delivery container and the side of the cut-out 76 in the storage container 10. In other examples, a different kind of sensor could be used in the vision system as an alternative to or in addition to a camera.

As described above, the datum edge 94 represents a reference point on the merge/separation conveyor station 72 such that when an edge of the storage container 10 is positioned against the datum edge 94, the exact position of the storage container 10 is known. Therefore the position of the cut-out 76 in the storage container 10 is also known, and since the side of the cut-out 76 is within the field of view 89 of the camera 87, the position of the side of the cut-out 76 can be used as a datum or reference point for measuring the position of the delivery container 78 inside the storage container 10.

FIG. 19 schematically illustrates a merged storage container 10 and delivery container 78, showing the field of view 89 of the camera (not shown). In the field of view 89 is part of the side of the storage container 10, showing the cut-out 76 of the storage container 10. An edge 93 of the cut-out is visible. Behind the side of the storage container 10 can be seen part of the side of the delivery container 78, i.e. the delivery container 78 is inside the storage container 10 and part of the side of the delivery container 78 can be seen through the cut-out 76 of the storage container 10. An opening 84 and a handle 95 can be seen in the delivery container 78. The opening 84 is one of a plurality of openings for engaging with the clamping device 74, as described earlier.

The apparatus 54 comprises a control system that facilitates full or semi-automated separation or combination of delivery containers 78 and storage containers 10. The control system comprises a processor. The camera 87 creates an image of the field of view 89, which is processed by the processor of the control system. Using the processed image, the control system can detect the opening 84 (in this illustration, the opening is a circular hole), and identify the centre point 91 of the opening 84. The processor can then determine the distance or separation 97 between the centre of the opening 84 in the delivery container 78 and the edge 97 of the cut-out 76 in the storage container 10.

The control system can then compare the distance 97 with a pre-determined distance or predetermined separation which represents the distance or separation 97 when the delivery container 78 is positioned centrally within the storage container 10. The predetermined distance is the distance between the centre of the opening 84 in the delivery container 78 and the edge 97 of the cut-out 76 in the storage container 10, when the delivery container 78 is positioned in the centre of the storage container 10. If the distance 97 is the predetermined distance or is within a given tolerance of the predetermined distance, then the control system determines that the delivery container 78 is positioned sufficiently centrally within the storage container 10, so no further alignment is required. However, if the distance 97 is not the same as the predetermined distance or not within a given tolerance of the predetermined distance, the control system determines that the delivery container 78 is not positioned centrally within the storage container 10. In this case the delivery container 78 is misaligned within the storage container 10, i.e. positioned farther towards one side rather than in the centre of the storage container 10. The control system can then adjust the distance that the clamping device 74 needs to move, in order to compensate for the delivery container 78 not being positioned centrally within the storage container 10.

It is important that the clamping device 74 is correctly positioned relative to the delivery container 78 so that the engagement features or pins 82 align with the engagement features or openings 84 in the delivery container 78, in order for the clamping device 74 to successfully engage with the delivery container 78 to effect the separation from the storage container 10.

The distance 97 is illustrated in FIG. 19 as being a horizontal distance. In the illustrated embodiment, the horizontal distance is the only direction that is important to compensate for, because the vertical position of the storage container 10 is fixed by the position of the merge/separation conveyor 72, and the vertical position of the delivery container 78 is fixed by the vertical position of the storage container 10, so there is no vertical misalignment. The distance 97 therefore can be measured in a purely horizontal direction, and the horizontal distance that the clamping device 74 moves can be adjusted to account for any horizontal misalignment of the of the delivery container 78 within the storage container 10.

In other examples, the distance 97 may be measured in more than one direction, for example in a horizontal direction and/or a vertical direction. If there is variation in the vertical position of the delivery container 78 (for example vertical misalignment of the delivery container 78 within the storage container 10, or if the delivery containers vary in height), the control system can also adjust for vertical position as well as horizontal position. In some examples the clamping device 74 could move vertically as well as horizontally, and in other examples the merge/separation conveyor unit can vary the vertical distance by which it moves up/down.

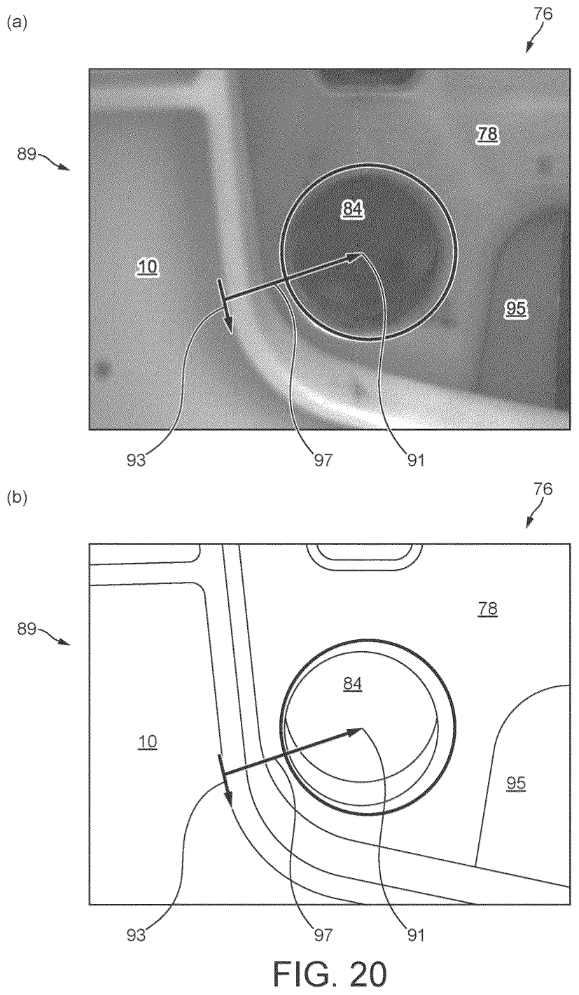

FIG. 20 (a and b) is another illustration of the field of view 89 of the camera. FIG. 20(a) is a photograph and FIG. 20(b) is a line drawing of the same field of view. A storage container 10 is visible in the foreground, with the edge 93 of the cut-out 76 in view. Behind the storage container 10, a delivery container 78 can be seen through the cut-out 76 in the storage container 10. An aperture 84 and handle 95 can be seen. After the camera 87 captures an image of the field of view 89, the processor processes the image and identifies the opening 84 of the delivery container 78 and the edge 93 of the cut-out 76 of the storage container 10. The circle outlined in white in FIG. 20(a) and in bold black in FIG. 20(b) illustrates the location where the processor has identified the opening 84 on the delivery container 78. The short arrow (white in FIG. 20(a), bold black in FIG. 20(b)) illustrates the location where the processor has identified the edge 93 of the cut-out 76 in the storage container 10. The longer arrow (white in FIG. 20(a), bold black in FIG. 20(b)) illustrates the distance 97 between the edge 93 of the cut-out 76 of the storage container 10 and the centre 91 of the opening 84 of the delivery container 78.

The processor of the control system can process the images captured by the camera 87 in order to distinguish between containers with different attributes. For example, the containers can be different colours, different materials, different textures, different shapes or sizes, or have identifying features such as bar codes or QR codes to assist in identifying and classifying the containers. The attributes can be used to distinguish between storage containers 10 and delivery containers 78 (for example, storage containers 10 could all be of one colour and delivery containers 78 could all be of another colour). Distinguishing between storage containers 10 and delivery containers 78 may be necessary in order to determine the position of a feature of the storage container 10 or delivery container 78, for example the edge 93 of the cut-out 76 of the storage container 10.

Alternatively or additionally, the attributes can be used to distinguish between different storage containers 10, e.g. storage containers 10 of different heights or different materials could be stored in different locations and/or at different temperatures, and/or the attributes can be used to distinguish between different delivery containers 78, e.g. delivery containers 78 with different bar codes could assigned to different consignments for shipping or delivery.

The control system may have a plurality of different algorithms for different kinds of container, and may select the appropriate algorithm depending on the attributes of the container. The camera 87 captures an image of the storage container 10 and delivery container 78, the processor processes the image, and the control system identifies the containers according to the attribute. The different algorithms for different kinds of container could, for example, require different predetermined distances and/or directions of movement, for example to accommodate different sizes or shapes of container. For example, consider a storage system with two different types of storage container 10, a first-type storage container 10 and a second-type storage container 10, where the first-type storage containers 10 are large storage containers for storing large items, and the second-type storage containers 10 are small storage containers for storing small items. The first-type and second-type storage containers 10 are merged with delivery containers 78 of a similar size to the storage containers 10, so the large first-type storage containers 10 contain large delivery containers 78, and the smaller second-type storage containers contain smaller delivery containers 78. When a combined storage container 10 and delivery container 78 arrives at the merge/separation station, the camera 87 captures an image of the field of view 89 including a part of both the storage container 10 and the delivery container 78. The image is sent to the processor for processing. After processing the image, the control system can determine whether the storage container 10 is a first-type storage container 10 or a second-type storage container 10, for example by the position of a feature or an edge of the storage container 10. If the storage container 10 is large, then the control system identifies the storage container 10 as a first-type storage container 10. The control system can then select a predetermined distance 97 that is appropriate for first-type storage containers 10. For example, the predetermined distance 97 may be a larger distance, since the first-type storage container 10 is a larger storage container 10 and the clamping device 74 may need to move farther in order to engage with the larger delivery container 78 within the first-type storage container 10. After the clamping device 74 has been moved by the appropriate distance, the delivery container 78 inside the first-type storage container 10 can grasped by the clamping device 74 and lifted out of the storage container 10. If, however, the storage container 10 is smaller in size, then the control system identifies the storage container 10 as a second-type storage container 10. The control system can then select a predetermined distance 97 that is appropriate for second-type storage containers 10. For example, the predetermined distance 97 may be a smaller distance, since the second-type storage container 10 is a smaller storage container 10 and the clamping device 74 may need to move less far in order to engage with the smaller delivery container 78 within the second-type storage container 10. After the clamping device 74 has been moved by the appropriate distance, the delivery container 78 inside the second-type storage container 10 can grasped by the clamping device 74 and lifted out of the storage container 10.

Alternatively or additionally, the control system can determine what should happen to the storage container 10 and/or the delivery container 78 at the next stage in the process. For example, after separating the storage container 10 and the delivery container 78, the control system can determine the next destination for the storage container 10 and/or the delivery container 78 depending on the attribute, e.g. directing one or both containers to a different location.

Consider a storage system with two different types of delivery container 78: a first-type delivery container for storing ambient temperature goods, black in colour, and a second-type delivery container which is insulated for storing frozen goods, and coloured white. When a combined storage container 10 and delivery container 78 arrives at the merge/separation station, the camera 87 captures an image of the field of view 89 including a part of both the storage container 10 and the delivery container 78. The image is sent to the processor for processing. After processing the image, the control system can determine whether the delivery container 78 is black in colour or white in colour. If the delivery container 78 is black in colour, then the control system identifies the delivery container 78 as a first-type delivery container. After the first-type delivery container 78 has been grasped by the clamping device 74 and lifted out of the storage container 10, the first-type delivery container 78 can be directed to a pick station for ambient-temperature goods in order to be used again for another customer order. If, however, the delivery container 78 is white in colour, then the control system identifies the delivery container 78 as a second-type delivery container. After the second-type delivery container 78 has been grasped by the clamping device 74 and lifted out of the storage container 10, the second-type delivery container 78 can be directed to a pick station for frozen goods in order to be used again for another customer order.

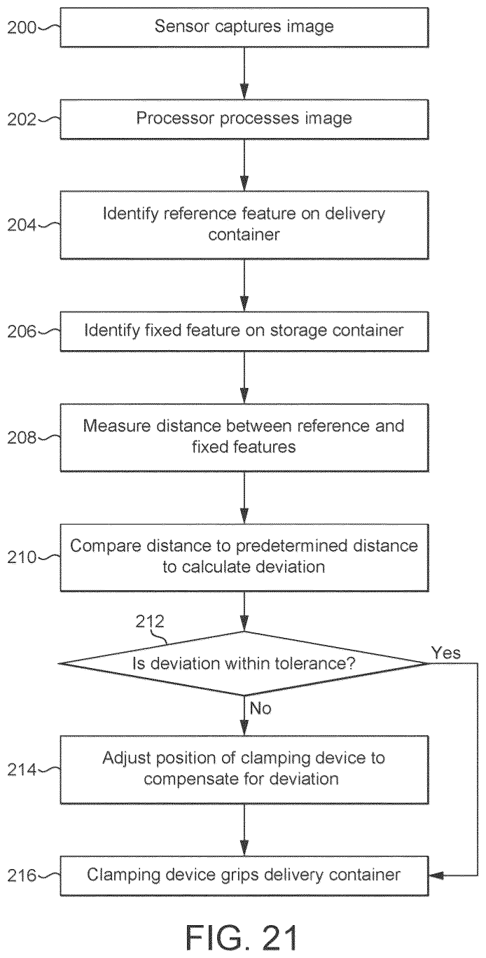

FIG. 21 is a flowchart illustrating the process of separating a delivery container 78 from a storage container 10, using the vision system to ensure that the clamping device 74 is aligned with the delivery container 78 in order to successfully engage with and lift the delivery container 78.

In a first step 200, the camera 87 captures an image of the camera's field of view 89. The field of view 89 includes part of the side of the storage container 10, with part of the side of the delivery container 78 visible through the cut-out 76 of the storage container 10. In the next step 202, the image captured by the camera 87 is processed by a processor. In step 204 the processed image is then used to identify a reference feature on the delivery container 78. In the example described above in relation to FIG. 19 this reference feature is an opening 84, but any reference feature on the delivery container 78 can be used. In step 206 the processed image is then used to identify a fixed feature on the storage container 10. In the example described above in relation to FIG. 19 this fixed feature is an edge 93 of the cut-out 76, but any fixed feature on the storage container 10 can be used. The fixed feature is referred to as “fixed” because its position is fixed relative to the datum edge 94, which fixes the position of the storage container 10. In step 208 the distance 97 between the reference feature on the delivery container 78 and the fixed feature on the storage container 10 is measured from the image. The distance 97 can be measured horizontally and/or vertically and/or in another direction, depending on the particular setup of the merge/separation station.

In a step 210, the control system compares the distance 97 to a predetermined distance which represents the distance between the fixed feature and the reference feature when the delivery container 78 is perfectly aligned within the storage container 10. In examples where the distance 97 is measured in more than one direction, e.g. a horizontal distance and a vertical distance, the distance 97 can be compared with the predetermined distance in more than one direction, i.e. a horizontal distance 97 can be compared with a predetermined horizontal distance and a vertical distance 97 can be compared with a predetermined vertical distance. In a step 212, the control system determines whether the distance 97 is within a tolerance of the predetermined distance, e.g. whether the deviation between the distance 97 and the predetermined distance is greater than a maximum permissible deviation. Again, in examples where the distance 97 is measured in more than one direction, different tolerances can be set for different directions, e.g. the control system can determine whether the horizontal deviation between the horizontal distance 97 and the predetermined horizontal distance is greater than a maximum permissible horizontal deviation, and the control system can determine whether the vertical deviation between the vertical distance 97 and the predetermined vertical distance is greater than a maximum permissible vertical deviation.

If the control system determines at step 212 that the distance 97 is within the tolerance, the control system moves on to step 216. If the control system determines that the distance is not within the tolerance, however, at a step 214 the control system adjusts the position of the clamping device 74 to compensate for the deviation. For example, the control system can instruct the clamping device to move a greater or smaller distance in order to compensate for the deviation between the distance 97 and the predetermined distance. If for example the deviation is 1 cm measured horizontally, the clamping device 74 can be instructed to move 1 cm in order to compensate for the misalignment of the delivery container 78 within the storage container 10. This ensures that the engagement pins 82 of the clamps 80 of the clamping device 74 will be able to successfully engage with the engagement features or openings 84 of the delivery container 78. If the control system did not account for the misalignment of the delivery container 78 within the storage container 10, the engagement pins 82 of the clamps 80 of the clamping device 74 would not be in the same position as the openings 84 of the delivery container 78, so the clamping device 74 would not be able to engage with the delivery container 78.

At a step 216, if the clamping device 74 is not already positioned above the merge/separation station 64, the clamping device 74 moves into the merge/separation station 64 above the delivery container 78. If the control system at step 212 has determined that the distance 97 is not within tolerance of the predetermined distance, the position of the clamping device is adjusted to compensate for the deviation between the distance 97 and the predetermined distance. Once the clamping device 74 is in position above the merged storage container 10 and delivery container 78, the clamping device is lowered towards the delivery container 78.

The clamps 80 of the clamping device 74 then grip the delivery container 78, by means of the engagement pins 82 of the clamps 80 engaging with the openings 84 of the delivery container 78. The delivery container 78 can then be lifted out of the storage container 10.

Further features of the present invention comprise:

1. An end effector for a robot having a robot base and a robot arm coupled to the robot base, the end effector being configured for separating and combining a delivery container and a storage container, the storage container comprising at least one cut out extending below the height of the delivery container, the end effector comprising:
i) a frame;
ii) a plurality of guides mounted to the frame, the plurality of guides being configured for interacting with at least exterior surface of the delivery container nested within the storage container such that interaction of the plurality of guides with the exterior surface of the delivery container centres the delivery container relative to the frame;
iii) a clamping device configured for clamping the delivery container nested within the storage container.

2. The end effector of feature 1, wherein the plurality of guides are configured for interacting with the corners of the delivery container.

3. The end effector of feature 1 or 2, wherein at least a portion of each of the plurality of guides is wedge shaped.

4. The end effector of any of the preceding features, wherein the clamping device comprises a pair of clamps configured for engaging with the side walls of a delivery container.

5. A combination and separation apparatus for combining and separating a delivery container and a storage container, the delivery container being containable within the storage container, the apparatus comprising a robot having a robot base, a robot arm coupled to the robot base, and an end effector as defined in any of the features 1 to 4 coupled to the robot arm, wherein the robot is configured to control movement of the end effector to combine and separate a delivery container and a storage container.

6. A system for combining and separating a delivery container and a storage container stored in a three dimensional grid framework structure, the system comprising:
i) a three dimensional grid framework structure comprising a plurality of upright members arranged to form a plurality of vertical storage columns for one or more combined delivery and storage containers to be stacked between the upright members and be guided by the upright members in a vertical direction, wherein the plurality of upright members are interconnected by a plurality of grid members arranged in a grid pattern to form a grid structure comprising a plurality of grid cells;
ii) a combination and separation apparatus as defined in feature 5, wherein the robot base of the robot is mounted to at least one of the plurality of grid cells such that the robot arm is configured for moving the end effector into a grid cell.

1-24. (canceled)

25. A combination and separation apparatus for combining and separating a delivery container and a storage container, the delivery container being able to be contained within the storage container, the apparatus comprising:
i) a storage container station configured for conveying a storage container in a first direction;
ii) a delivery container station configured for conveying a delivery container in a second direction;
iii) a combined station configured for conveying a combined delivery container and storage container in a third direction; and
iv) a merge/separation station including a clamping device for clamping a delivery container and a lifting device configured for combining or separating a storage container and a delivery container;
wherein the merge/separation station is configured to combine the storage container and the delivery container when the storage container station and the delivery container station are configured for respectively conveying the storage container and the delivery container to the merge/separation station such that the combined station is configured for receiving the combined delivery container and storage container from the merge/separation station; and/or
the merge/separation station is configured for separating the storage container and the delivery container when the combined station is configured for conveying a combined delivery container and storage container to the merge/separation station such that the storage container station and the delivery container station are configured to respectively receive the storage container and the delivery container from the merge/separation station;
wherein the first, second and third directions are parallel to each other.

26. The apparatus of claim 25, wherein any one or more of the storage container station, delivery container station, combination station and the merge/separation station comprises:
a transfer mechanism configured for transferring a respective storage container, delivery container or combined delivery container and storage container between the merge/separation station and their respective storage container station, delivery container station or the combined station.

27. The apparatus of claim 26, wherein the transfer mechanism comprises:
at least one conveyor unit, and/or
optionally wherein the transfer mechanism is configured to transfer the clamping device between the merge/separation station and the delivery container station, and/or
optionally wherein the lifting device is arranged for lifting or lowering a storage container towards or away from the delivery container so as to combine or separate a storage container and a delivery container clamped to the clamping device, and/or
optionally wherein the transfer mechanism of the merge/separation station includes a merge/separation conveyor unit and wherein the lifting device is arranged for lifting or lowering the merge/separation conveyor unit to combine the storage container with the delivery container in a raised position of the merge/separation conveyor unit and lower the storage container away from the delivery container to separate the delivery container and the storage container in a lowered position of the merge/separation conveyor unit, and/or
optionally wherein the delivery container station is directly opposite the combined station such that in the raised or lowered position of the merge/separation conveyor unit, a continuous conveyor system extends from the delivery container station to the combined station via the merge/separation station.

28. The apparatus of claim 25, wherein the lifting device is configured and arranged for lifting or lowering a delivery container towards or away from the storage container so as to combine or separate a storage container and a delivery container clamped to the clamping device.

29. The apparatus of claim 25, wherein the combined station is arranged directly above the storage container feeding station, or
wherein the combination station is arranged directly below the delivery container feeding station.

30. The apparatus of claim 25, wherein the merge/separation station, the storage container station, the delivery container station, and the combination station all lie in a same vertical plane; and/or
wherein the merging/separation station is arranged between the storage container feeder station and the delivery container feeding station.

31. The apparatus of claim 25, wherein the merging/separation station comprises:
an alignment mechanism configured for engaging with the delivery container so as to position the delivery container relative to the clamping device; and
optionally wherein the lifting device is arranged for lifting the storage containers into engagement with the alignment mechanism.

32. The apparatus of claim 25, wherein the clamping device comprises:
a pair of arms configured to be moveable to clamp at least one side wall of the delivery container.

33. The apparatus as claimed in claim 25, wherein the merging/separation station comprises:
a datum edge and a datum clamp, said datum clamp being configured and arranged for clamping a storage container against the datum edge so as to position the storage container relative to clamping device.

34. An order processing system comprising at least one combination and separation apparatus according to claim 25 arranged in a container sortation apparatus, said container sortation apparatus comprising:
i) a first combination and separation apparatus, said first combination and separation apparatus being a combination and separation apparatus as defined in claim 25 and being arranged to separate a combined delivery container and storage container into a delivery container and a storage container;
ii) a second combination and separation apparatus, said second combination and separation apparatus being a combination and separation apparatus as defined in claim 25 and being arranged to combine the storage container separated from the first combination and separation apparatus with a delivery container; and
iii) a bridge configured for feeding a storage container in a fourth direction from the first combination and separation apparatus to the second combination and separation apparatus.

35. The order processing system of claim 34, wherein the fourth direction is substantially orthogonal to the first, second and third directions.

36. The order processing system of claim 34, comprising:
i) a three dimensional grid framework structure including a plurality of upright members arranged to form a plurality of vertical storage columns for one or more combined delivery and storage containers to be stacked between the upright members and be guided by the upright members in a vertical direction, wherein the plurality of upright members are interconnected by a plurality of grid members arranged in a grid pattern to form a grid structure including a plurality of grid cells; said plurality of vertical storage columns including at least one delivery port column being configured and arranged for delivering a combined delivery container and storage container in a vertical direction through a grid cell to the first combination and separation apparatus and at least one pick-up port column being configured and arranged for receiving a combined delivery container and storage container in a vertical direction through a grid cell from the second combination and separation station; and
ii) one or more load handling devices operative on the grid structure and configured for transporting a combined delivery container and storage container to the at least one delivery port column and/or for picking up a combined delivery container and storage container from the at least one pick-up column, each of the one or more load handling devices including a lifting device for lifting and/or lowering a combined delivery container and storage container.

37. The order processing system of claim 36, wherein the at least one delivery port column and/or the at least pick-up port column comprises:
a vertical chute having an opening in cooperation with a grid cell of the grid structure for delivering or picking-up a combined delivery container and storage container by a load handling device through the grid cell; and
optionally wherein the at least one of the delivery port column and/or the at least pick-up port column includes at least one bin lifting device configured for lifting or lowering a combined delivery container and storage container at least partially along their respective vertical chute.

38. A method of operating an order processing system, the method comprising:
i) transporting a combined delivery container and storage container in a vertical direction down at least one delivery port column to a first combination and separation apparatus;
ii) separating the delivery container and the storage container in a merge/separation station;
iii) moving the separated storage container to a second combination and separation apparatus;
iv) combining the separated storage container with a delivery container in the second combination and separation apparatus; and
v) transporting the combined delivery container and storage container in a vertical direction up and at least one pick-up port column towards a grid structure;
wherein each of the first and second combination and storage apparatus is configured to include:
a three dimensional grid framework structure including a plurality of upright members arranged to form a plurality of vertical storage columns for one or more combined delivery and storage containers to be stacked between the upright members and be guided by the upright members in a vertical direction, wherein the plurality of upright members are interconnected by a plurality of grid members arranged in a grid pattern to form a grid structure including a plurality of grid cells; said plurality of vertical storage columns including at least one delivery port column being configured and arranged for delivering a combined delivery container and storage container in a vertical direction through a grid cell to the first combination and separation apparatus and at least one pick-up port column being configured and arranged for receiving a combined delivery container and storage container in a vertical direction through a grid cell from the second combination and separation station; and
one or more load handling devices operative on the grid structure and configured for transporting a combined delivery container and storage container to the at least one delivery port column and/or for picking up a combined delivery container and storage container from the at least one pick-up column, each of the one or more load handling devices including a lifting device for lifting and/or lowering a combined delivery container and storage container.

39. The method of claim 38, comprising:
transporting the combined delivery container and storage container in a vertical direction down the at least one delivery column and/or up the at least one pick-up station by the lifting device of the load handling device operative on the grid structure; and
optionally transporting the combined delivery container and storage container in a vertical direction down the at least one delivery column and/or up the at least one pick-up column by the bin lifting device.
